(19) United States
(12) Patent Application Publication
(10) Pub. No.: US 2023/0276506 A1
(43) Pub. Date: Aug. 31, 2023

(54) ACCESS POINT, STATION, AND WIRELESS COMMUNICATION METHOD

(71) Applicant: GUANGDONG OPPO MOBILE TELECOMMUNICATIONS CORP., LTD., Dongguan, Guangdong (CN)

(72) Inventor: LEI HUANG, Singapore (SG)

(21) Appl. No.: 18/313,181

(22) Filed: May 5, 2023

Related U.S. Application Data
(63) Continuation of application No. PCT/CN2020/128543, filed on Nov. 13, 2020.

(51) Int. Cl. H04W 74/08; H04W 72/04

(52) U.S. Cl. CPC H04W 74/0833; H04W 72/04

(57) ABSTRACT

An access point (AP), a station (STA), and a wireless communication method are provided. The wireless communication method includes configuring, by an AP, a trigger based aggregated physical layer protocol data unit (TB A-PPDU) to a set of STAs, where in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs.

### CROSS-REFERENCE TO RELATED APPLICATION(S)

This application is a continuation of International Application No. PCT/CN2020/128543, filed Nov. 13, 2020, the entire disclosure of which is hereby incorporated by reference.

### TECHNICAL FIELD

The present disclosure relates to the field of communication systems, and more particularly, to an access point (AP), a station (STA), and a wireless communication method.

### BACKGROUND

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineers (IEEE) 802.11) network may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

In recent times, to support increased numbers of devices supporting WLAN, such as smartphones, more APs have been deployed. Despite increase in use of WLAN devices supporting the IEEE 802.11ax high efficiency (HE) WLAN standard, that provide high performance relative to WLAN devices supporting the legacy IEEE 802.11g/n/ac standard, a WLAN system supporting higher performance is required due to WLAN users' increased use of high volume content such as a ultra-high definition video. Although a conventional WLAN system has aimed at increase of bandwidth and improvement of a peak transmission rate, actual users thereof could not feel drastic increase of such performance.

In a task group called IEEE 802.11be, extremely high throughput (EHT) WLAN standardization is under discussion. The EHT WLAN aims at achieving extremely high throughput (EHT) and/or improving performance felt by users demanding high-capacity, high-rate services while supporting simultaneous access of numerous stations in an environment in which a plurality of APs is densely deployed and coverage areas of APs overlap.

IEEE 802.11be EHT WLAN supports a bandwidth (BW) up to 320 MHz. It is expected that high efficiency (HE) STAs will exist with EHT STAs in a same EHT basic service set (BSS). In order to maximize throughput of an EHT BSS with large BW (e.g. 320 MHz), an aggregated physical layer (PHY) protocol data unit (A-PPDU) has been proposed.

No specified method for performing an uplink random access by STAs using a trigger based (TB) aggregated physical layer (PHY) protocol data unit (A-PPDU) is provided. How to perform an uplink random access by STAs using a TB A-PPDU in an efficient manner is an open issue.

Therefore, there is a need for an access point (AP), a station (STA), and a wireless communication method, which can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability.

### SUMMARY

In a first aspect of the present disclosure, a wireless communication method comprises configuring, by an access point (AP), a trigger based (TB) aggregated physical layer (PHY) protocol data unit (A-PPDU) to a set of stations (STAs), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs.

In a second aspect of the present disclosure, an access point (AP) comprises a memory, a transceiver, and a processor coupled to the memory and the transceiver. The processor is configured to configure a trigger based (TB) aggregated physical layer (PHY) protocol data unit (A-PPDU) to a set of stations (STAs), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs.

In a third aspect of the present disclosure, a station (STA) comprises a memory, a transceiver, and a processor coupled to the memory and the transceiver. The processor is configured to determine a trigger based (TB) aggregated physical layer (PHY) protocol data unit (A-PPDU) from an access point (AP), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of an uplink multi-user (MU) transmission according to an embodiment of the present disclosure.

FIG. 2A is a schematic diagram illustrating an example of high efficiency (HE) trigger-based (TB) physical layer (PHY) protocol data unit (PPDU) format according to an embodiment of the present disclosure.

FIG. 2B is a schematic diagram illustrating an example of extremely high throughput (EHT) TB PPDU format according to an embodiment of the present disclosure.

FIG. 3 is a schematic diagram illustrating an example of a wireless communications system according to an embodiment of the present disclosure.

FIG. 4 is a schematic diagram illustrating an example of a wireless communications system according to another embodiment of the present disclosure.

FIG. 5 is a schematic diagram illustrating an example of a wireless communications system according to another embodiment of the present disclosure.

FIG. 6 is a block diagram of one or more stations (STAs) and an access point (AP) of communication in a wireless communications system according to an embodiment of the present disclosure.

FIG. 7 is a flowchart illustrating a wireless communication method performed by an AP according to an embodiment of the present disclosure.

FIG. 8 is a flowchart illustrating a wireless communication method performed by a STA according to another embodiment of the present disclosure.

FIG. 9 is a schematic diagram illustrating an example of 160 MHz bandwidth (BW) FD-A-PPDU according to an embodiment of the present disclosure.

FIG. 10A is a schematic diagram illustrating an example of 320 MHz BW FD-A-PPDU in an EHT basic service set (BSS) for option 1A according to an embodiment of the present disclosure.

FIG. 10B is a schematic diagram illustrating an example of 320 MHz BW FD-A-PPDU in an EHT BSS for option 1B according to an embodiment of the present disclosure.

FIG. 10C is a schematic diagram illustrating an example of 320 MHz BW FD-A-PPDU in an EHT BSS for option 1C according to an embodiment of the present disclosure.

FIG. 10D is a schematic diagram illustrating an example of 320 MHz BW FD-A-PPDU in an EHT BSS for option 1D according to an embodiment of the present disclosure.

FIG. 10E is a schematic diagram illustrating an example of 320 MHz BW FD-A-PPDU in an EHT BSS for option 1E according to an embodiment of the present disclosure.

FIG. 11 is a schematic diagram illustrating an example of trigger frame format according to an embodiment of the present disclosure.

FIG. 12 is a schematic diagram illustrating an example of user information (info) field format according to an embodiment of the present disclosure.

FIG. 13 is a flowchart illustrating an uplink orthogonal frequency division multiple access (OFDMA) based random access (UORA) procedure performed by an EHT STA according to a first method provided by an embodiment of the present disclosure.

FIG. 14 is a schematic diagram illustrating an example of the UORA procedure according to the first method provided by an embodiment of the present disclosure.

FIG. 15 is a flowchart illustrating a UORA procedure performed by an EHT STA according to a second method provided by an embodiment of the present disclosure.

FIG. 16 is a schematic diagram illustrating an example of the UORA procedure according to the second method provided by an embodiment of the present disclosure.

FIG. 17 is a flowchart illustrating a UORA procedure performed by an EHT STA according to a third method provided by an embodiment of the present disclosure.

FIG. 18 is a schematic diagram illustrating an example of the UORA procedure according to the third method provided by an embodiment of the present disclosure.

FIG. 19 is a flowchart illustrating a UORA procedure performed by an EHT STA according to a fourth method provided by an embodiment of the present disclosure.

FIG. 20 is a schematic diagram illustrating an example of the UORA procedure according to the fourth method provided by an embodiment of the present disclosure.

FIG. 21 is a schematic diagram illustrating an example of a first information element format according to an embodiment of the present disclosure.

FIG. 22 is a schematic diagram illustrating an example of correspondence between four UORA methods and field settings of the first information element according to an embodiment of the present disclosure.

FIG. 23 is a flowchart illustrating a UORA procedure performed by an EHT STA according to an embodiment of the present disclosure.

FIG. 24 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Institute of electrical and electronics engineers (IEEE) 802.11be extremely high throughput (EHT) WLAN supports a bandwidth (BW) up to 320 MHz. It is expected that high efficiency (HE) stations (STAs) will exist with extremely high throughput (EHT) STAs in a same EHT basic service set (BSS). In order to maximize throughput of an EHT BSS with large BW (e.g. 320 MHz), an aggregated physical layer (PHY) protocol data unit (A-PPDU) in some embodiments of the present disclosure has been proposed.

FIG. 1 illustrates an example of an uplink multi-user (MU) transmission according to an embodiment of the present disclosure. FIG. 1 illustrates that, in some embodiments, when receiving a trigger frame from an access point (AP) which is used to solicit a TB FD-A-PPDU transmission from HE STAs and EHT STAs, each of scheduled HE STAs and EHT STAs will transmit a TB PPDU based on the scheduling information in the received trigger frame. The TB PPDU transmitted by each of scheduled HE STAs is an HE TB PPDU while the TB PPDU transmitted by each of scheduled EHT STAs is a HE TB PPDU or an EHT TB PPDU. The HE TB PPDUs and EHT TB PPDUs transmitted by all scheduled HE STAs and EHT STAs constitute a TB FD-A-PPDU. The AP will transmit a multi-STA BA frame in a response to the received TB FD-A-PPDU.

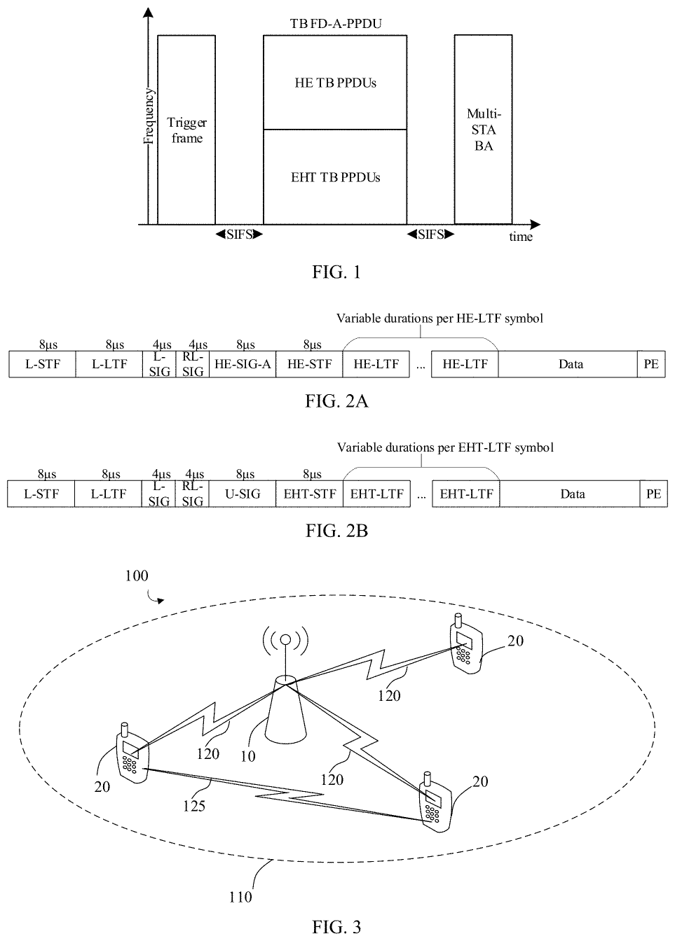

FIG. 2A illustrates an example of high efficiency (HE) trigger-based (TB) PPDU format according to an embodiment of the present disclosure. FIG. 2B illustrates an example of extremely high throughput (EHT) TB PPDU format according to an embodiment of the present disclosure. The HE TB PPDU and EHT TB PPDU formats as illustrated in FIG. 2A and FIG. 2B are used for a transmission that is a response to a trigger frame from an AP. In a HE TB PPDU, L-STF, L-LTF, L-SIG field, RL-SIG field, and HE-SIG-A field are called pre-HE modulated fields while the HE-STF, HE-LTF, data field, and PE field are called HE modulated fields. In an EHT TB PPDU, L-STF, L-LTF, L-SIG field, RL-SIG field, and U-SIG field are called pre-EHT modulated fields while EHT-STF, EHT-LTF, data field, and PE field are called EHT modulated fields.

Each HE-LTF or EHT-LTF symbol has the same GI duration as each data symbol, which is 0.8 μs, 1.6 μs or 3.2 μs. The HE-LTF field comprises three types: 1× HE-LTF, 2× HE-LTF, and 4× HE-LTF. Similarly, the EHT-LTF field comprises three types: 1× EHT-LTF, 2× EHT-LTF, and 4× EHT-LTF. The duration of each 1× HE-LTF/EHT-LTF, 2× HE-LTF/EHT-LTF, or 4× HE-LTF/EHT-LTF symbol without GI is 3.2 μs, 6.4 μs, or 12.8 μs. Each data symbol without GI is 12.8 μs. The PE field duration of a HE TB PPDU is 0 μs, 4 μs, 8 μs, 12 μs, or 16 μs; while the PE field duration of an EHT TB PPDU is 0 μs 4 μs, 8 μs, 12 μs, 16 μs, or 20 μs.

The following description is directed to certain implementations for the purposes of describing the innovative aspects of the present disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), global system for mobile communications (GSM), GSM/general packet radio service (GPRS), enhanced data GSM environment (EDGE), terrestrial trunked radio (TETRA), wideband-CDMA (W-CDMA), evolution data optimized (EV-DO), 1×EV-DO, EV-DO Rev A, EV-DO Rev B, high speed packet access (HSPA), high speed downlink packet access (HSDPA), high speed uplink packet access (HSUPA), evolved high speed packet access (HSPA+), long term evolution (LTE), AMPS, or other known signals that are used to communicate within a wireless, cellular or internet of things (IOT) network, such as a system utilizing 3G, 4G, or 5G, or further implementations thereof, technology.

Techniques are disclosed for wireless devices to support multiplexing clients of different generations in trigger-based transmissions. For example, an access point (AP) that supports multiple generations of station (STA) may support uplink transmissions in, for example, an extremely high throughput (EHT) wireless communications system. EHT systems also may be referred to as ultra-high throughput (UHT) systems, next generation Wi-Fi systems, or next big thing (NBT) systems, and may support coverage for multiple types of mobile stations (STAs). For example, an AP in an EHT system may provide coverage for EHT STAs, as well as legacy (or high efficiency (HE)) STAs. The AP may multiplex boy EHT STAs and HE STAs in trigger-based uplink transmissions. That is, the AP may operate using techniques to provide backwards compatibility for HE STAs, while providing additional functionality for EHT STAs.

To trigger uplink transmissions from one or more STAs of different generations, the AP may transmit a trigger frame. The trigger frame may be formatted as a legacy trigger frame so that HE STAs may detect and process the trigger frame to determine uplink transmissions. The AP may include resource unit (RU) allocations in the trigger frame. An STA may receive the trigger frame, identify the RU allocation corresponding to that STA, and may transmit an uplink transmission to the AP using the allocated resources. Legacy STAs may support transmitting in a narrower bandwidth (for example, 160 megahertz (MHz)) than EHT STAs (which may transmit in a 320 MHz bandwidth). The AP may include an additional indication in the trigger frame for EHT STAs, so that the EHT STAs may identify the bandwidth to use (for example, the legacy bandwidth or the greater EHT bandwidth).

In some implementations, the AP and EHT STAs may use anew EHT RU allocation table when operating in the larger bandwidth. An EHT STA receiving the trigger frame may use a same RU allocation field as HE STAs to determine the RU allocation index, but may use a different table to look up an entry corresponding to the RU allocation index. In some other implementations, the AP may include an additional bit in the trigger frame to indicate to EHT STAs whether to use a primary or a secondary 160 MHz portion of the 320 MHz bandwidth. The EHT STAs may use a legacy RU allocation table, which also may include an additional entry corresponding to this wider bandwidth. In yet some other implementations, the AP may order the RU allocations in the trigger frame in increasing order. An EHT STA may parse the user information for multiple STAs, and may sum the allocated resources for each STA preceding the resource allocation for that EHT STA. The EHT STA may determine the resources for transmission based on the sum and the ordering of the allocations. In each of these implementations, legacy STAs may utilize legacy operations to determine a bandwidth for transmission based on a bandwidth field in the trigger frame. Additionally, if the trigger frame does not indicate the wider EHT bandwidth, an EHT STA may utilize this legacy bandwidth field to determine the resources for transmission.

FIG. 3 illustrates an example of a wireless communications system according to an embodiment of the present disclosure. The wireless communications system may be an example of a wireless local area network (WLAN) 100 (also known as a Wi-Fi network) (such as next generation, next big thing (NBT), ultra-high throughput (UHT) or EHT Wi-Fi network) configured in accordance with various aspects of the present disclosure. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, a STA 20 may be located in the intersection of more than one coverage area 110 and may associate with more than one AP 10. A single AP 10 and an associated set of STAs 20 may be referred to as a BSS. An ESS is a set of connected BSSs. A distribution system (not shown) may be used to connect APs 10 in an ESS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 120 may include Wi-Fi direct connections, Wi-Fi tunneled direct link setup (TDLS) links, and other group connections. STAs 20 and APs 10 may communicate according to the WLA RAdio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, etc. In some other implementations, peer-to-peer connections or ad hoc networks may be implemented within the WLAN 100.

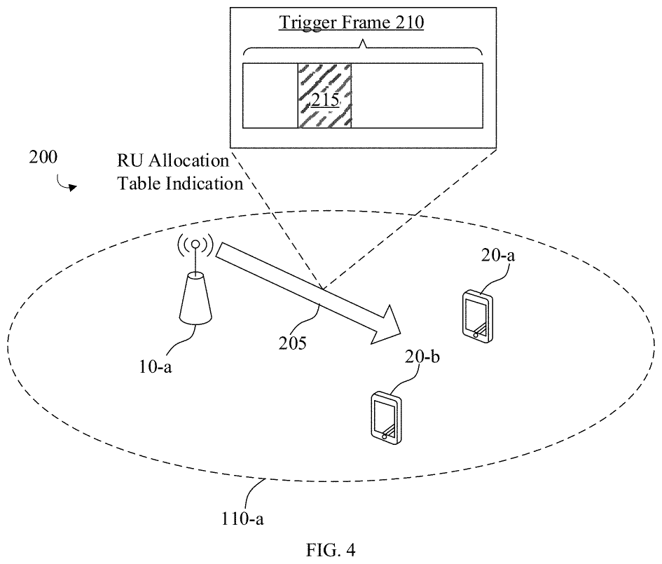

FIG. 4 illustrates an example of a wireless communications system according to another embodiment of the present disclosure. The wireless communications system 200 may be an example of a next generation or EHT Wi-Fi system, and may include an AP 10-a and STAs 20-a and 20-b, and a coverage area 110-a, which may be examples of components described with respect to FIG. 3. The AP 10-a may transmit a trigger frame 210 including an RU allocation table indication 215 on the downlink 205 to the STAs 20.

In some implementations, a wireless communications system 200 may be a next generation Wi-Fi system (such as, an EHT system). In some implementations, wireless communications system 200 may also support multiple communications systems. For instance, wireless communications system 200 may support EHT communications and HE communications. In some implementations, the STA 20-a and the STA 20-b may be different types of STAs. For example, the STA 20-a may be an example of an EHT STA, while the STA 20-b may be an example of an HE STA. The STA 20-b may be referred to as a legacy STA.

In some instances, EHT communications may support a larger bandwidth than legacy communications. For instance, EHT communications may occur over an available bandwidth of 320 MHz, whereas legacy communications may occur over an available bandwidth of 160 MHz. Additionally, EHT communications may support higher modulations than legacy communications. For instance, EHT communications may support 4K quadrature amplitude modulation (QAM), whereas legacy communications may support 1024 QAM. EHT communications may support a larger number of spatial streams (such as, space-time-streams) than legacy systems. In one non-limiting illustrative example, EHT communications may support 16 spatial streams, whereas legacy communications may support 8 spatial streams. In some cases, EHT communications may occur a 2.4 GHz channel, a 5 GHz channel, or a 6 GHz channel in unlicensed spectrum.

In some implementations, AP 10-a may transmit a trigger frame 210 to one or more STAs 20 (such as, STA 20-a and STA 20-b). In some implementations, the trigger frame may solicit an uplink transmission from the STAs 20. However, the trigger frame 210 may be received by an EHT STA 20-a and HE STA 20-b. The trigger frame 210 may be configured to solicit an uplink transmission from only HE STAs 20-b. In some implementations, trigger frame 210 may be configured to solicit an uplink transmission from EHT STAs 20-a. In some other implementations, the trigger frame 210 may be configured to solicit an uplink transmission from one or more EHT STAs 20-a and one or more HE STAs 20-b.

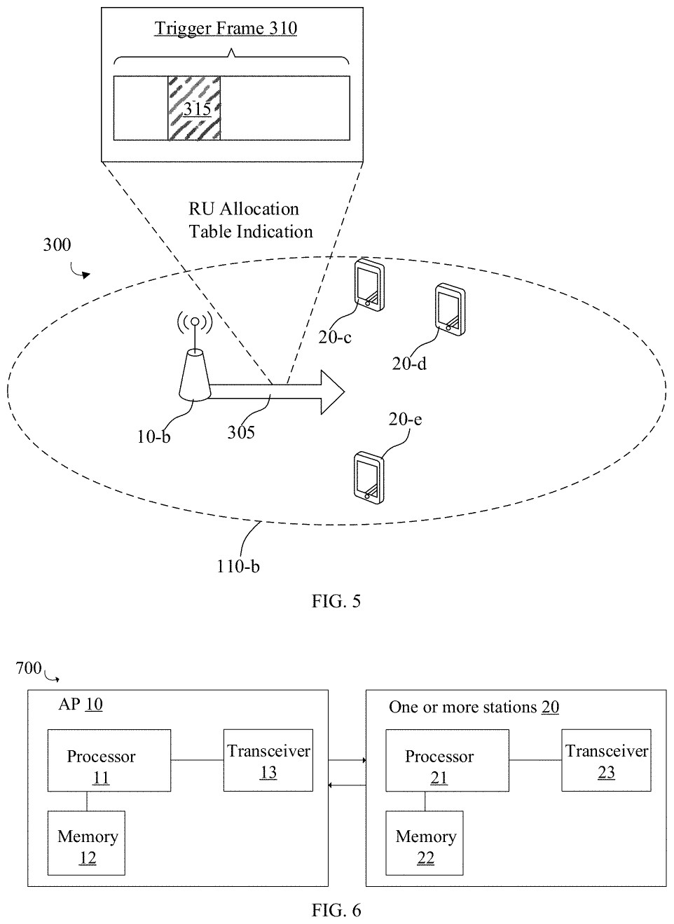

FIG. 5 illustrates an example of a wireless communications system according to another embodiment of the present disclosure. The wireless communications system 300 may be an example of a post-EHT Wi-Fi system, and may include an AP 10-b. AP 10-b may be an example of a post-EHT AP 10. The wireless communications system 300 may include HE STA 20-c, EHT STA 20-d, and post-EHT STA 20-e, and a coverage area 110-b, which may be examples of components described with respect to FIGS. 5 and 6. The AP 10-b may transmit a trigger frame 310 including an RU allocation table indication 315 on the downlink 305 to the STAs 20. In some implementations, STAs 20 may be referred to as clients.

In some implementations, an EHT AP 10 may serve both HE STAs 20 and EHT STAs 20. The EHT AP 10 may send a trigger frame that may trigger a response from HE STAs 20 only, from EHT STAs 20 only, or from both HE STAs 20 and EHT STAs 20. STAs 20 that are scheduled in the trigger frame may respond with trigger-based PPDUs. In some implementations, an EHT AP 10 may trigger HE STAs 20 (and not EHT STAs 20) by sending an HE trigger frame format. In some implementations, an EHT AP 10 may trigger EHT STAs 20 (and not EHT STAs 20) by sending an HE trigger frame format or an HE trigger frame format including some field or bit allocation adjustments. In some implementations, an EHT AP 10 may trigger EHT STAs 20 and HE STAs 20 by sending an HE trigger frame format including some field or bit allocation adjustments.

The trigger frame 310 may solicit a response from one or more EHT STAs 20 or one or more HE STAs 20, or both. In some implementations, STAs 20 may not transmit unsolicited uplink transmissions in response to trigger frame 310. In some implementations, trigger frame 310 may solicit an uplink orthogonal frequency division multiple access (OFDMA) transmission or an OFDMA with multi-user multiple-input multiple-output (MU-MIMO) transmission.

FIG. 6 illustrates one or more stations (STAs) 20 and an access point (AP) 10 of communication in a wireless communications system 700 according to an embodiment of the present disclosure. FIG. 6 illustrates that, the wireless communications system 700 includes an access point (AP) 10 and one or more stations (STAs) 20. The AP 10 may include a memory 12, a transceiver 13, and a processor 11 coupled to the memory 12, the transceiver 13. The one or more STAs 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to configure a trigger based (TB) aggregated physical layer (PHY) protocol data unit (A-PPDU) to a set of stations (STAs), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs. This can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability.

In some embodiments, the processor 21 is configured to determine a trigger based (TB) aggregated physical layer (PHY) protocol data unit (A-PPDU) from an access point (AP), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs. This can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability.

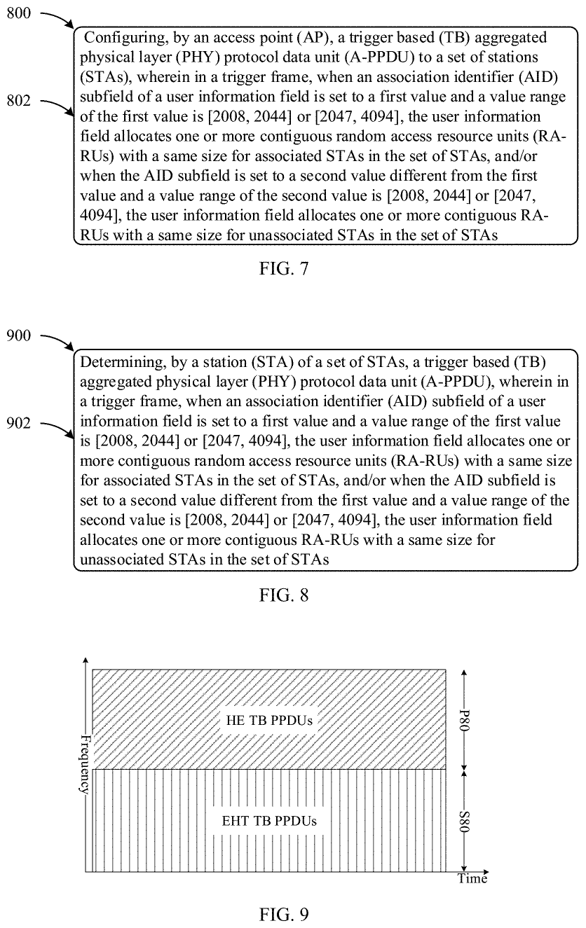

FIG. 7 illustrates a wireless communication method 800 performed by an AP according to an embodiment of the present disclosure. In some embodiments, the method 800 includes: a block 802, configuring, by an access point (AP), a trigger based (TB) aggregated physical layer (PHY) protocol data unit (A-PPDU) to a set of stations (STAs), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs. This can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability.

FIG. 8 illustrates a wireless communication method 900 performed by a STA according to an embodiment of the present disclosure. In some embodiments, the method 900 includes: a block 902, determining, by a station (STA) of a set of STAs, a trigger based (TB) aggregated physical layer (PHY) protocol data unit (A-PPDU), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs. This can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability.

In some embodiments, the AID subfield comprises an AID12 subfield. In some embodiments, the set of STAs comprises high efficiency (HE) STAs and/or extremely high throughput (EHT) STAs, and the trigger frame is used to solicit a TB A-PPDU transmission from the HE STAs and/or the EHT STAs. In some embodiments, wherein if the AID subfield is set to the first value, the associated STAs comprises associated EHT STAs, and/or the trigger frame further comprises a user information field with an AID subfield set to 0; and/or if the AID subfield is set to the second value, the unassociated STAs comprises unassociated EHT STAs, and/or the trigger frame further comprises a user information field with an AID subfield set to 2045. In some embodiments, the first value of the AID subfield comprises 2043, and/or the second value of the AID subfield comprises 2044. In some embodiments, the trigger frame comprises a user information list field, and the user information field with the AID subfield set to the first value or the second value is placed at an end of the user information list field of the trigger frame. In some embodiments, the user information field with the AID subfield set to the first value or the second value and the user information field with the AID subfield set to 0 or 2045 are placed at the end of the user information list field of the trigger frame. In some embodiments, in an uplink orthogonal frequency division multiple access (OFDMA) based random access (UORA) procedure performed by the STA, when the trigger frame is received by the STA from the AP, the STA decrements a OFDMA random access backoff (OBO) counter according to a first RA-RU set indicated in the received trigger frame. In some embodiments, the first RA-RU set comprises eligible RA-RUs for the STAs indicated in the received trigger frame. In some embodiments, the first RA-RU set comprises eligible RA-RUs for the EHT STAs, especially for the EHT STAs, and/or for the HE STAs indicated in the received trigger frame. In some embodiments, the STA is configured to determine whether the OBO counter is greater than a number of RA-RUs in the first RA-RU set.

In some embodiments, if the STA determines the OBO counter is greater than the number of RA-RUs in the first RA-RU set, the STA decrements the OBO counter by the number of RA-RUs in the first RA-RU set and stops the UORA procedure. In some embodiments, if the STA determines the OBO counter is not greater than the number of RA-RUs in the first RA-RU set, the STA decrements the OBO counter to zero. In some embodiments, when the STA determines the OBO counter is not greater than the number of RA-RUs in the first RA-RU set, the STA randomly selects one of RA-RUs in a second RA-RU set indicated in the received trigger frame and transmits a TB PPDU at the selected RA-RU. In some embodiments, the second RA-RU set comprises eligible RA-RUs for the STAs indicated in the received trigger frame. In some embodiments, the second RA-RU set comprises eligible RA-RUs for the EHT STAs, especially for the EHT STAs, and/or for the HE STAs indicated in the received trigger frame. In some embodiments, a format of the transmitted TB PPDU depends on whether the selected RA-RU is a RA-RU for the HE STAs or a RA-RU especially for the EHT STAs. In some embodiments, if the selected RA-RU is the RA-RU for the HE STAs, the transmitted TB PPDU is a HE TB PPDU. In some embodiments, if the selected RA-RU is the RA-RU especially for the EHT STAs, the transmitted TB PPDU is an EHT TB PPDU.

In some embodiments, the AP is configured to transmit, by the AP, a first information element to the set of the STAs, and the first information element indicates configuration information on the first RA-RU set and/or the second RA-RU set. In some examples, the first information element is a UORA parameter set element. In some embodiments, the TB A-PPDU comprises a TB frequency-domain (FD) A-PPDU (TB FD-A-PPDU). In some embodiments, the TB A-PPDU comprises at least one first TB PPDU and at least one second TB PPDU, the at least one first TB PPDU comprises one or more HE TB PPDUs, and the at least one second TB PPDU comprises one or more EHT TB PPDUs for uplink multi-user (MU) transmission. In some embodiments, the TB A-PPDU comprises at least one first TB PPDU and at least one second TB PPDU, the at least one first TB PPDU comprises one or more HE TB PPDUs, and the at least one second TB PPDU comprises one or more EHT TB PPDUs and/or one or more post-EHT TB PPDUs for uplink multi-user (MU) transmission. In some embodiments, the at least one first TB PPDU comprises first symbols and the at least one second TB PPDU comprise second symbols, and/or a first field of the at least one first TB PPDU has a same symbol duration and/or a same guard interval (GI) duration as a second field of the at least one second TB PPDU.

In some embodiments, the TB A-PPDU is configured in a basic service set (BSS) with a first bandwidth. In some embodiments, the BSS comprises an extremely high throughput (EHT) BSS. In some embodiments, the first bandwidth is greater than 80 MHz. In some embodiments, the first bandwidth of the TB A-PPDU is equal to 160 MHz. In some embodiments, the first bandwidth of the TB A-PPDU is equal to 320 MHz. In some embodiments, the first symbols comprise HE long training field (HE-LTF) symbols. In some embodiments, the second symbols comprise EHT-LTF symbols. In some embodiments, the first field comprises a HE-LTF. In some embodiments, the second field comprises an EHT-LTF. In some embodiments, a number of HE-LTF symbols is same as or different from a number of EHT-LTF symbols. In some embodiments, when the number of HE-LTF symbols is same as the number of EHT-LTF symbols, each HE-LTF symbol and/or each EHT-LTF symbol has a different duration or a same duration from each data symbol. In some embodiments, each HE-LTF symbol without a GI and/or each EHT-LTF symbol without a GI comprises 6.4 μs or 12.8 μs. In some embodiments, when the number of HE-LTF symbols is different from the number of EHT-LTF symbols, each HE-LTF symbol and/or each EHT-LTF symbol has a same duration from each data symbol. In some embodiments, each HE-LTF symbol without a GI and/or each EHT-LTF symbol without a GI comprises 12.8 μs. In some embodiments, pre-HE modulated fields of the HE TB PPDU and pre-EHT modulated fields of the EHT TB PPDU can be kept orthogonal in frequency domain symbol-by-symbol.

In some embodiments, the uplink MU transmission is determined in a first bandwidth channel if the STA is a first type of STA and/or is determined in a second bandwidth channel if the STA is a second type of STA and/or is determined in a third bandwidth channel if the STA is a third type of STA. In some embodiments, the first type of STA comprises a HE STA, and the first bandwidth channel comprises a primary 80 MHz channel (P80). In some embodiments, the second type of STA comprises an EHT STA, and the second bandwidth channel comprises a non-primary 80 MHz channel and/or the third type of STA comprises a post-EHT STA, and the third bandwidth channel comprises a non-primary 80 MHz channel. In some embodiments, the non-primary 80 MHz channel comprises an 80 MHz frequency segment outside the P80. In some embodiments, the non-primary 80 MHz channel comprises a secondary 80 MHz channel (S80) in a 160 MHz channel or a 320 MHz channel. In some embodiments, in a 160 MHz BW FD-A-PPDU, a BW allocated to the at least one HE STA is P80; while a BW allocated to the at least one EHT STA is S80. In some embodiments, one or more HE TB PPDUs are transmitted in P80 and one or more EHT TB PPDUs are transmitted in S80. In some embodiments, in a 320 MHz BW FD-A-PPDU, a BW allocated to the at least one HE STA is P80 or primary 160 MHz channel (P160); while a BW allocated to the at least one EHT STA is one of two 80 MHz frequency segments of secondary 160 MHz channel (S160), S160, a combination of S80 and one of two 80 MHz frequency segments of S160, or a combination of S80 and S160.

In some embodiments, for the 320 MHz BW FD-A-PPDU, the BW allocation in the TB FD-A-PPDU comprises at least one of the following options: option 1A: when S80 is punctured, a BW allocated to the at least one HE STA is P80 and a BW allocated to the at least one EHT STA is S160; option 1B: when one of two 80 MHz frequency segments of S160 is punctured, the BW allocated to the at least one HE STA is P160 and the BW allocated to the at least one EHT STA is the other 80 MHz frequency segment of S160; option 1C: when one of two 80 MHz frequency segments of S160 is punctured, the BW allocated to the at least one HE STA is P80 and the BW allocated to the at least one EHT STA is S80 and the other 80 MHz frequency segment of S160; option 1D: when none of 80 MHz frequency segments is punctured, the BW allocated to the at least one HE STA is P160 and the BW allocated to the at least one EHT STA is S160; or option 1E: when none of 80 MHz frequency segments is punctured, the BW allocated to the at least one HE STA is P80 and the BW allocated to the at least one EHT STA is S80 and S160. In some embodiments, the 320 MHz BW FD-A-PPDU comprise one or more HE TB PPDUs and one or more EHT TB PPDUs and/or one or more post-EHT TB PPDUs. In some embodiments, the TB FD-A-PPDU comprises one or more HE TB PPDUs and one or more EHT TB PPDUs in an EHT BSS and/or the TB FD-A-PPDU comprises one or more HE TB PPDUs, one or more EHT TB PPDUs, and one or more post-EHT TB PPDUs in a post-EHT BSS.

In some embodiments, a subfield of the user information field indicates whether the user information field follows a HE format or an EHT format. In some embodiments, the subfield is set to a third value (for example, 0 or 1) to indicate the HE format and/or set to a fourth value (for example, 1 or 0) to indicate the EHT format. In some embodiments, if the subfield of the user information field is set to the third value, the EHT STA indicated by the AID subfield transmits a HE TB PPDU. In some embodiments, if the subfield of the user information field is set to the fourth value, the EHT STA indicated by the AID subfield transmits an EHT TB PPDU. In some embodiments, RA-RU information subfield of the user information field comprises a number of RA-RU subfield which indicates a number of contiguous RA-RUs. In some embodiments, if the AID subfield is set to 0 or 2045, an RU allocation subfield indicates to the HE STAs a starting RU of one or more contiguous RA-RUs allocated by the user information field. In some embodiments, if the AID subfield of the user information field is set to the first value or the second value, the RU allocation subfield of the user information field, together with a lower/upper 160 MHz segment subfield, indicates a starting RU of one or more contiguous RA-RUs allocated by the user information field. In some embodiments, when the AID subfield of the user information field is set to the first value or the second value, the subfield of the user information field is set to the fourth value (for example, 1 or 0) to indicate the EHT format. In some embodiments, when the AID subfield of the user information field is set to 0 or 2045, the subfield of the user information field is set to the third value (for example, 0 or 1) to indicate the HE format. In some embodiments, if the trigger frame comprises the user information field with the AID subfield set to the first value, the trigger frame comprises the user information field with the AID subfield set to 0.

In some embodiments, if the trigger frame comprises the user information field with the AID subfield set to the second value, the trigger frame comprises the user information field with the AID subfield set to 2045. In some embodiments, when the EHT STA identifies the user information field with the AID subfield set to a value matched with an AID of the EHT STA, the EHT STA stops parsing remaining user information fields in the trigger frame. In some embodiments, the RA-RUs for the associated EHT STAs comprise the RA-RUs for the associated HE STAs and the RA-RUs especially for the associated EHT STAs; and/or the RA-RUs for the unassociated EHT STAs comprise the RA-RUs for the unassociated HE STAs and the RA-RUs especially for the unassociated EHT STAs; and/or for an associated EHT STA, the RA-RUs for the HE STAs, the RA-RUs especially for the EHT STAs, and the RA-RUs for the EHT STAs refer to the RA-RUs for the associated HE STAs, the RA-RUs especially for the associated EHT STAs, and the RA-RUs for the associated EHT STAs, respectively; and/or for an unassociated EHT STA, the RA-RUs for the HE STAs, the RA-RUs especially for the EHT STAs, and the RA-RUs for the EHT STAs refer to the RA-RUs for the unassociated HE STAs, the RA-RUs especially for the unassociated EHT STAs, and the RA-RUs for the unassociated EHT STAs, respectively.

In some embodiments, a RA-RU for associated HE STAs refers a RA-RU that is allocated by the user information field with the AID subfield set to 0; and/or a RA-RU for unassociated HE STAs refers to a RA-RU that is allocated by the user information field with the AID subfield set to 2045; and/or a RA-RU especially for associated EHT STAs refers to a RA-RU that is allocated by the user information field with the AID subfield set to the first value; and/or a RA-RU especially for unassociated EHT STAs refers to a RA-RU that is allocated by the user information field with the AID subfield set to the second value; and/or a RA-RU for associated EHT STAs refers to a RA-RU that is allocated by the user information field with the AID subfield set to 0 or the first value; and/or a RA-RU for unassociated EHT STAs refers to a RA-RU that is allocated by the user information field with the AID subfield set to 2045 or the second value. In some embodiments, if the STA is an associated EHT STA, the STA considers a RA-RU for associated EHT STAs to be eligible if the STA is capable of transmitting a HE TB PPDU or an EHT TB PPDU in the RA-RU according to parameters indicated in a common information field and in the user information field that allocates the RA-RU.

In some embodiments, if the STA is the unassociated EHT STA, the STA considers a RA-RU for unassociated EHT STAs to be eligible if the STA supports all transmit parameters indicated in the common information field and in the user information field that allocates the RA-RU. In some embodiments, in the trigger frame, a number of eligible RA-RUs for the associated EHT STAs is larger than a number of eligible RA-RUs for the associated HE STAs. In some embodiments, the first information element comprises a first field which indicates configuration information on the first RA-RU set and a second field which indicates configuration information on the second RA-RU set. In some embodiments, the first field of the first information element is set to a fifth value (for example, 0) to indicate the first RA-RU set to comprise eligible RA-RUs especially for the EHT STAs; and/or set to a sixth value (for example, 1) to indicate the first RA-RU set to comprise eligible RA-RUs for the EHT STAs; and/or set to a seventh (for example, 2) to indicate the first RA-RU set to comprise eligible RA-RUs for the HE STAs. In some embodiments, the second field of the first information element is set to an eighth value (for example, 0) to indicate the second RA-RU set to comprise eligible RA-RUs especially for the EHT STAs; and/or set to a ninth value (for example, 1) to indicate the second RA-RU set to comprise eligible RA-RUs for the EHT STAs. In some embodiments, the first information element is a UORA parameter set element. In some embodiments, the first information element is included in a management frame.

According to some embodiments of the present invention, in an EHT BSS with a large BW (e.g. 160 MHz or 320 MHz), a TB FD-A-PPDU used for uplink MU transmission may comprise one or more HE TB PPDUs and one or more EHT TB PPDUs if a HE-LTF field has a same symbol duration and a same GI duration as a EHT-LTF field. The number of HE-LTF symbols may be the same as or different from the number of EHT-LTF symbols. When the number of HE-LTF symbols is the same as the number of EHT-LTF symbols, each HE-LTF/EHT-LTF symbol may have a different duration or a same duration from each data symbol. In other words, each HE-LTF/EHT-LTF symbol without GI may be 6.4 μs or 12.8 μs. When the number of HE-LTF symbols is different from the number of EHT-LTF symbols, each HE-LTF/EHT-LTF symbol shall have a same duration as each data symbol. In other words, each HE-LTF/EHT-LTF symbol without GI should be 12.8 μs. As a result, the pre-HE modulated fields of a HE TB PPDU and the pre-EHT modulated fields of an EHT TB PPDU can be kept orthogonal in frequency domain symbol-by-symbol.

In some embodiments, for uplink MU transmission, each scheduled HE STA may park in primary 80 MHz channel (P80); while each scheduled EHT STA may park in one of non-primary 80 MHz channel(s) via an enhanced SST mechanism. A non-primary 80 MHz channel is an 80 MHz frequency segment outside P80, e.g. secondary 80 MHz channel (S80) in a 160 MHz or 320 MHz channel.

FIG. 9 illustrates an example of 160 MHz bandwidth part (BW) FD-A-PPDU according to an embodiment of the present disclosure. FIG. 9 illustrates that, in some embodiments, for a 160 MHz BW FD-A-PPDU, a BW allocated to HE STAs is P80 while a BW allocated to EHT STAs is S80. In this case, one or more HE TB PPDUs may be transmitted in P80 while one or more EHT TB PPDUs may be transmitted in S80.

According to some embodiments of the present invention, in a 320 MHz BW TB FD-A-PPDU, a BW allocated to HE STAs is P80 or primary 160 MHz channel (P160); while a BW allocated to EHT STAs is one of two 80 MHz frequency segments of secondary 160 MHz channel (S160), S160, a combination of S80 and one of two 80 MHz frequency segments of S160 or a combination of S80 and S160. For a 320 MHz BW FD-A-PPDU, there may have the following five options for BW allocation in the TB FD-A-PPDU.

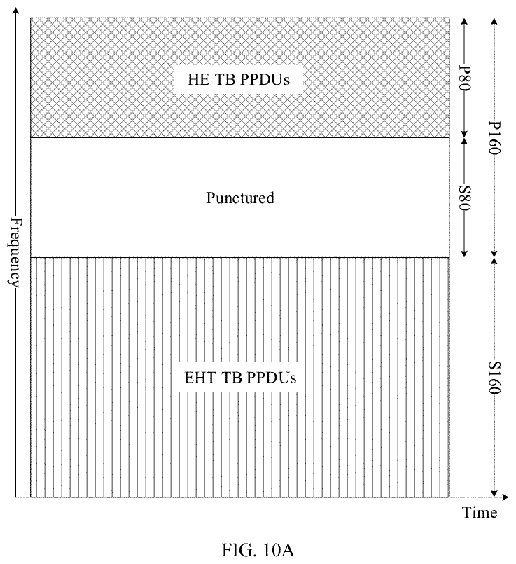

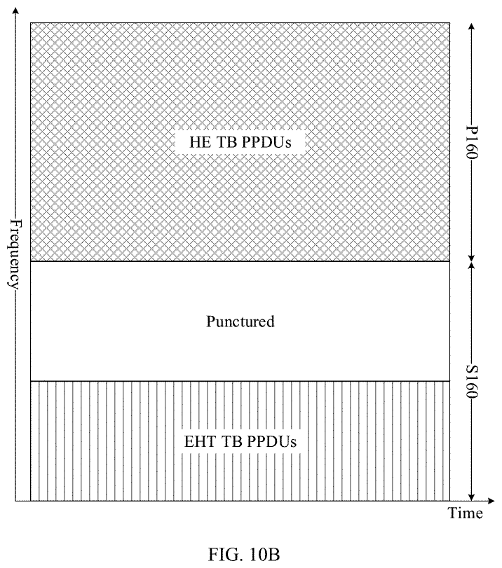

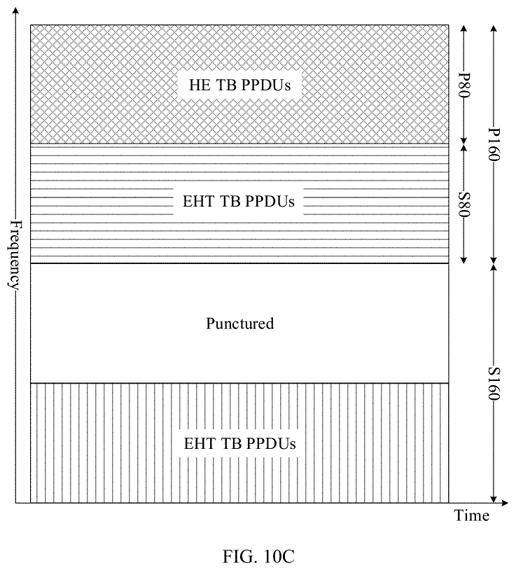

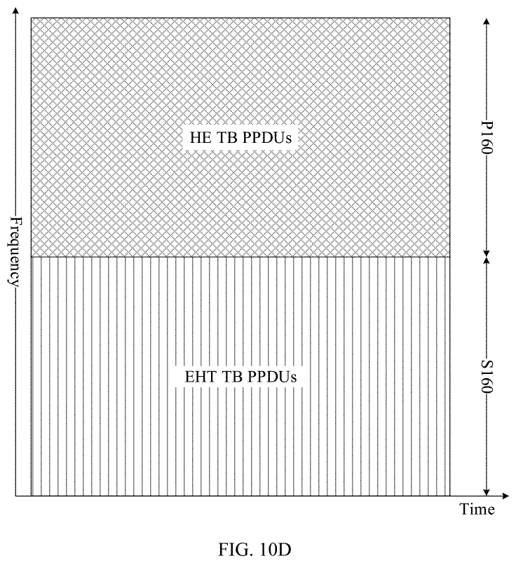

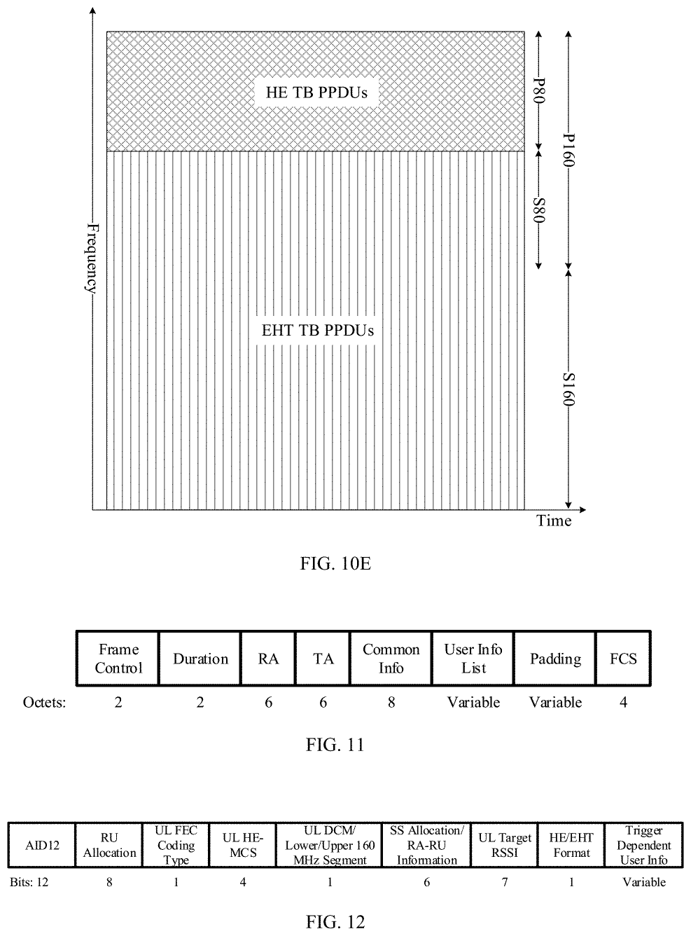

FIG. 10A illustrates an example of 320 MHz BW FD-A-PPDU in an EHT basic service set (BSS) for option 1A according to an embodiment of the present disclosure. Option 1A: When S80 is punctured, BW allocated to HE STAs is P80 and BW allocated to EHT STAs is S160, as illustrated in FIG. 10A. One or more HE TB PPDUs may be transmitted in P80 while one or more EHT TB PPDUs may be transmitted in S160.

FIG. 10B illustrates an example of 320 MHz BW FD-A-PPDU in an EHT BSS for option 1B according to an embodiment of the present disclosure. Option 1B: When one of two 80 MHz frequency segments of 5160 is punctured, BW allocated to HE STAs is P160 and BW allocated to EHT STAs is the other 80 MHz frequency segment of S160, as illustrated in FIG. 10B. One or more HE TB PPDUs may be transmitted in P160 while one or more EHT TB PPDUs may be transmitted in the unpunctured 80 MHz frequency segment of S160.

FIG. 10C illustrates an example of 320 MHz BW FD-A-PPDU in an EHT BSS for option 1C according to an embodiment of the present disclosure. Option 1C: When one of two 80 MHz frequency segments of 5160 is punctured, BW allocated to HE STAs is P80 and BW allocated to EHT STAs is S80 and the other 80 MHz frequency segment of S160, as illustrated in FIG. 10C. One or more HE TB PPDUs may be transmitted in P80 while one or more EHT TB PPDUs may be transmitted in S80 and the unpunctured 80 MHz frequency segment of S160.

FIG. 10D illustrates an example of 320 MHz BW FD-A-PPDU in an EHT BSS for option 1D according to an embodiment of the present disclosure. Option 1D: When none of 80 MHz frequency segments is punctured, BW allocated to HE STAs is P160 and BW allocated to EHT STAs is S160, as illustrated in FIG. 10D. One or more HE TB PPDUs may be transmitted in P160 while one or more EHT TB PPDUs may be transmitted in S160.

FIG. 10E illustrates an example of 320 MHz BW FD-A-PPDU in an EHT BSS for option 1E according to an embodiment of the present disclosure. Option 1E: When none of 80 MHz frequency segments is punctured, BW allocated to HE STAs is P80 and BW allocated to EHT STAs is S80 and S160, as illustrated in FIG. 10E. One or more HE TB PPDUs may be transmitted in P80 while one or more EHT TB PPDUs may be transmitted in S80 and S160.

FIG. 11 illustrates an example of trigger frame format according to an embodiment of the present disclosure. FIG. 12 illustrates an example of user information (info) field format according to an embodiment of the present disclosure. According to some embodiments of the present invention, an example trigger frame that can be used to solicit a TB FD-A-PPDU transmission from HE STAs and EHT STAs is illustrated in FIG. 11. The user Information list field comprises one or more user information fields (User Info fields). The User Info field format is illustrated in FIG. 12. A subfield of a User Info field indicates whether the User Info field follows the HE or EHT format. The subfield of a User Info field may refer to a HE/EHT format subfield of a User Info field. In some embodiments, the subfield can be set to different values to indicate HE format and EHT format, respectively. In an example, the subfield is set to 0 to indicate HE format and set to 1 to indicate EHT format. In another example, the subfield is set to 1 to indicate HE format and set to 0 to indicate EHT format. The value of the subfield of a User Info field determines how the remaining subfields of the User Info field are interpreted. If the subfield of a User Info field is set to 0, the EHT STA indicated by the AID12 subfield will transmit a HE TB PPDU. If the subfield of a User Info field is set to 1, the EHT STA indicated by the AID12 subfield will transmit an EHT TB PPDU.

According to some embodiments of the present invention, when the AID12 subfield of a User Info field is set to 0, the User Info field allocates one or more contiguous RA-RUs with a same size for associated HE STAs; and when the AID12 subfield is set to 2045, the User Info field allocates one or more contiguous RA-RUs with a same size for unassociated HE STAs. The RA-RU Information subfield of the User Info field comprises a Number Of RA-RU subfield which indicates the number of contiguous RA-RUs. If the AID12 subfield is 0 or 2045, the RU Allocation subfield indicates to HE STAs the starting RU of one or more contiguous RA-RUs allocated by the User Info field. When the AID12 subfield of a User Info field is set to a first value and a value range of the first value is [2008, 2044] or [2047, 4094] (e.g. 2043), the User Info field allocates one or more contiguous RA-RUs with a same size especially for associated EHT STAs; and when the AID12 subfield is set to a second value different from the first value and a value range of the second value is [2008, 2044] or [2047, 4094] (e.g. 2044), the User Info field allocates one or more contiguous RA-RUs with a same size especially for unassociated EHT STAs. If the AID12 subfield of a User Info field is set to the first or second value, the RU Allocation subfield of the User Info field, together with the Lower/Upper 160 MHz Segment subfield, indicates the starting RU of one or more contiguous RA-RUs allocated by the User Info field.

According to some embodiments of the present invention, when the AID12 subfield of a User Info field is set to the first value or second value, the subfield of the User Info field shall be set to 1 to indicate the EHT format. When the AID12 subfield of a User Info field is set to 0 or 2045, the subfield of the User Info field shall be set to 0 to indicate the HE format.

According to some embodiments of the present invention, if a trigger frame comprises at least one User Info field with the AID12 subfield set to the first value, the Trigger frame may comprise at least one User Info field with the AID12 subfield set to 0 in order for associated HE STAs to have a chance of performing UORA like associated EHT STAs. Similarly, if a trigger frame comprises at least one User Info field with the AID12 subfield set to the second value, the trigger frame may comprise at least one User Info field with the AID12 subfield set to 2045 in order for unassociated HE STAs to get an opportunity of performing UORA like unassociated EHT STAs.

According to some embodiments of the present invention, when a trigger frame comprises at least one User Info field with the AID12 subfield set to the first or second value and at least one User Info field with the AID12 subfield set to 0 or 2045, the at least one User Info field with the AID12 subfield set to the first or second value and the at least one User Info field with the AID12 subfield set to 0 or 2045 shall be placed at the end of the User Info List field of the Trigger frame. As a result, when an EHT STA identifies a User Info field with the AID12 subfield value matched with its AID, it can stop parsing remaining User Info fields in the Trigger frame since only a single RU or MRU are allowed to be allocated to an EHT STA in a TB FD-A-PPDU.

For easy of presentation, the following terminologies are used according to some embodiments of the present invention: RA-RU for associated HE STAs: a RA-RU that is allocated by a User Info field with the AID12 subfield set to 0; RA-RU for unassociated HE STAs: a RA-RU that is allocated by a User Info field with the AID12 subfield set to 2045; RA-RU especially for associated EHT STAs: a RA-RU that is allocated by a User Info field with the AID12 subfield set to the first value; RA-RU especially for unassociated EHT STAs: a RA-RU that is allocated by a User Info field with the AID12 subfield set to the second value; RA-RU for associated EHT STAs: a RA-RU that is allocated by a User Info field with the AID12 subfield set to 0 or the first value; and/or RA-RU for unassociated EHT STAs: a RA-RU that is allocated by a User Info field with the AID12 subfield set to 2045 or the second value.

In other words, RA-RUs for associated EHT STAs comprises RA-RUs for associated HE STAs and RA-RUs especially for associated EHT STAs; and RA-RUs for unassociated EHT STAs comprises RA-RUs for unassociated HE STAs and RA-RUs especially for unassociated EHT STAs. In addition, for an associated EHT STA, RA-RUs for HE STAs, RA-RUs especially for EHT STAs and RA-RUs for EHT STAs refer to RA-RUs for associated HE STAs, RA-RUs especially for associated EHT STAs and RA-RUs for associated EHT STAs, respectively. For an unassociated EHT STA, RA-RUs for HE STAs, RA-RUs especially for EHT STAs and RA-RUs for EHT STAs refer to RA-RUs for unassociated HE STAs, RA-RUs especially for unassociated EHT STAs and RA-RUs for unassociated EHT STAs, respectively.

First Method of UORA:

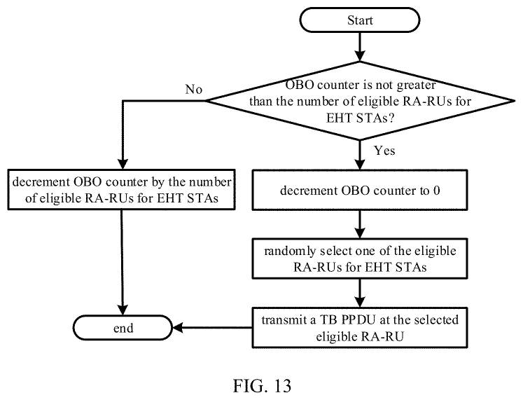

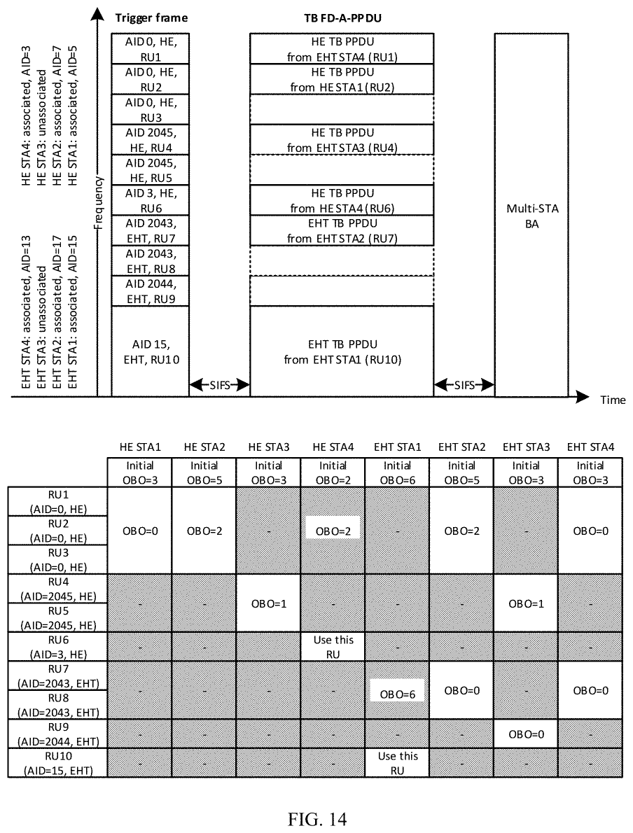

FIG. 13 is a flowchart illustrating an uplink orthogonal frequency division multiple access (OFDMA) based random access (UORA) procedure performed by an EHT STA according to a first method provided by an embodiment of the present disclosure. FIG. 14 is a schematic diagram illustrating an example of the UORA procedure according to the first method provided by an embodiment of the present disclosure. A UORA procedure performed by an EHT STA when receiving a trigger frame from an AP according to a first method is illustrated in FIG. 13. According to the first method, in some embodiments, the STA decrements its OBO counter according to a first RA-RU set indicated in the received Trigger frame, which comprise eligible RA-RUs for EHT STAs. If the STA is an associated EHT STA, it should consider a RA-RU for associated EHT STAs to be eligible if it is capable of transmitting a HE TB PPDU or an EHT TB PPDU in the RA-RU according to the parameters indicated in the Common Info field and in the User Info field that allocates the RA-RU. If the STA is an unassociated EHT STA, it may consider a RA-RU for unassociated EHT STAs to be eligible if it supports all the transmit parameters indicated in the Common Info field and in the User Info field that allocates the RA-RU.

The STA determines whether its OBO counter is greater than the number of eligible RA-RUs for EHT STAs in the received Trigger frame. If the STA determines its OBO counter is greater than the number of eligible RA-RUs for EHT STAs in the received Trigger frame, the STA will decrement its OBO counter by the number of eligible RA-RUs for EHT STAs and then stops the UORA procedure. If the STA determines its OBO counter is not greater than the number of eligible RA-RUs for EHT STAs in the received Trigger frame, the STA will decrement its OBO counter to zero and win RA-RU contention. After that, the STA randomly selects one of RA-RUs in a second RA-RU set indicated in the received Trigger frame, which comprise eligible RA-RUs for EHT STAs, and then transmit a TB PPDU at the selected RA-RU. The format of the transmitted TB PPDU depends on whether the selected RA-RU is a RA-RU for HE STAs or a RA-RU especially for EHT STAs. If the selected RA-RU is a RA-RU for HE STAs, the transmitted TB PPDU is a HE TB PPDU. If the selected RA-RU is a RA-RU especially for EHT STAs, the transmitted TB PPDU is an EHT TB PPDU.

The transmit procedure using RA-RUs according to the first method is illustrated in FIG. 14. In this example, a Trigger frame allocates three RA-RUs for associated HE STAs (i.e. RU1, RU2 and RU3) and two RA-RUs for unassociated HE STAs (i.e. RU4 and RU5). The Trigger frame also allocates two RA-RUs especially for associated EHT STAs (i.e. RU7 and RU8) and one RA-RU especially for unassociated EHT STAs (i.e. RU9). Before the Trigger frame was sent by the AP, HE STA 1, STA 2, STA 3 and STA 4 had initial OBO values of 3, 5, 3 and 2 respectively. EHT STA 1, STA 2, STA 3 and STA 4 had initial OBO values of 6, 5, 3 and 3 respectively. Upon receiving the Trigger frame, HE STA 4, which is associated with the AP and has pending frames for the AP, is allocated a dedicated RU (RU6). The STA does not contend for RA-RUs and instead transmits its pending frames on RU6 using a HE TB PPDU. HE STA 1 and STA 2, both associated with the AP and having pending frames for the AP, decrement their respective OBO counters by the number of eligible RA-RUs for associated HE STAs indicated in the Trigger frame. Since HE STA 1's OBO counter decrements to 0, it transmits its pending frames on RU2 using a HE TB PPDU that it randomly selects from the set of eligible RA-RUs for associated HE STAs (i.e., RU1, RU2 and RU3). Since HE STA 2's OBO counter decrements to a nonzero value, it maintains the new OBO value (2) until it receives a later Trigger frame carrying RA-RUs for associated HE STAs. HE STA 3, which is not associated with the AP but has a pending frame for the AP, decrements its OBO counter by the number of eligible RA-RUs for unassociated HE STAs indicated in the Trigger frame. Since HE STA 3's OBO counter decrements to a nonzero value, it maintains the new OBO value (1) until it receives a later Trigger frame carrying RA-RUs for unassociated HE STAs.

On the other hand, EHT STA 1, which is associated with the AP and has pending frames for the AP, is allocated a dedicated RU (RU10). The STA does not contend for RA-RUs and instead transmits its pending frames on RU10 using an EHT TB PPDU. EHT STA 2 and STA 4, both associated with the AP and having pending frames for the AP, decrement their respective OBO counters by the number of eligible RA-RUs for associated EHT STAs indicated in the Trigger frame. Since EHT STA 2's OBO counter decrements to 0, it transmits its pending frames on RU7 using an EHT TB PPDU that it randomly selects from the set of eligible RUs for associated EHT STAs (i.e., RU1, RU2, RU3, RU7 and RU8). Since EHT STA 4's OBO counter decrements to 0 as well, it transmits its pending frames on RU1 using a HE TB PPDU that it randomly selects from the set of eligible RUs for EHT STAs. EHT STA 3, which is not associated with the AP but has a pending frame for the AP, decrements its OBO counter by the number of eligible RA-RUs for unassociated EHT STAs indicated in the Trigger frame. Since EHT STA 3's OBO counter decrements to 0, it transmits its pending frames on RU4 using an HE TB PPDU that it randomly selects from the set of eligible RUs for unassociated EHT STAs (i.e., RU4, RU5 and RU9).

According to the first method, in some embodiments, in a Trigger frame, the number of eligible RA-RUs for associated EHT STAs may be larger than that for associated HE STAs. As a result, when receiving a Trigger frame from an AP, associated EHT STAs may have a larger probability of winning RA-RU contention than associated HE STAs. Similarly, unassociated EHT STAs may have a larger probability of winning RA-RU contention than unassociated HE STAs.

According to the first method, in some embodiments, in addition to eligible RA-RU especially for associated EHT STAs, associated EHT STAs winning RA-RU contention can make use of eligible RA-RUs for associated HE STAs for TB PPDU transmission, which may reduce probability of TB PPDU transmission collision among associated EHT STAs winning RA-RU contention. Similarly, probability of TB PPDU transmission collision among unassociated EHT STAs winning RA-RU contention may also be reduced. This may be particularly useful when EHT STAs are much more than HE STAs in an EHT BSS.

Second Method for UORA:

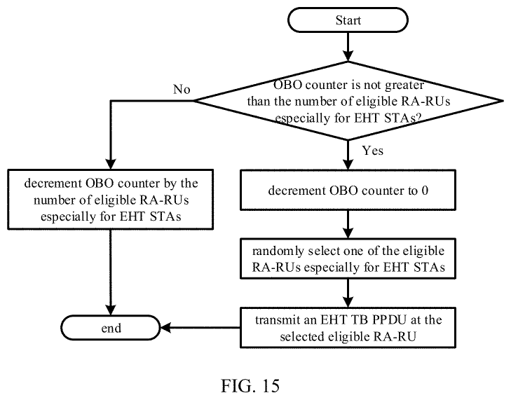

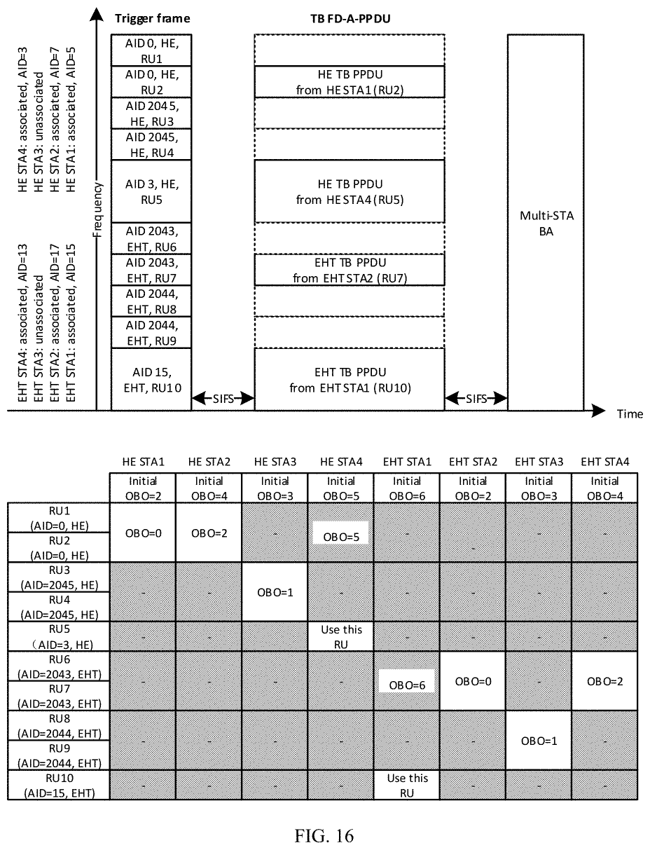

FIG. 15 is a flowchart illustrating a UORA procedure performed by an EHT STA according to a second method provided by an embodiment of the present disclosure. FIG. 16 is a schematic diagram illustrating an example of the UORA procedure according to the second method provided by an embodiment of the present disclosure. A UORA procedure performed by an EHT STA when receiving a Trigger frame from an AP according to a second method is shown in FIG. 15. According to the second method, in some embodiments, the STA decrements its OBO counter according to a first RA-RU set indicated in the received Trigger frame, which comprise eligible RA-RUs especially for EHT STAs. If the STA is an associated EHT STA, it should consider a RA-RU especially for associated EHT STAs to be eligible if it is capable of transmitting an EHT TB PPDU in the RA-RU according to the parameters indicated in the Common Info field and in the User Info field that allocates the RA-RU. If the STA is an unassociated EHT STA, it may consider a RA-RU especially for unassociated EHT STAs to be eligible if it supports all the transmit parameters indicated in the Common Info field and in the User Info field that allocates the RA-RU.

The STA determines whether its OBO counter is greater than the number of eligible RA-RUs especially for EHT STAs in the received Trigger frame. If the STA determines its OBO counter is greater than the number of eligible RA-RUs especially for EHT STAs in the received Trigger frame, the STA will decrement its OBO counter by the number of eligible RA-RUs especially for EHT STAs and then stops the UORA procedure. If the STA determines its OBO counter is not greater than the number of eligible RA-RUs especially for EHT STAs in the received Trigger frame, the STA will decrement its OBO counter to zero and win RA-RU contention. After that, the STA randomly selects one of RA-RUs in a second RA-RU set indicated in the received Trigger frame, which comprise eligible RA-RUs especially for EHT STAs, and then transmit an EHT TB PPDU at the selected RA-RU.

According to the second method of UORA, in some embodiments, in a Trigger frame, if the number of RA-RUs for associated HE STAs is similar to the number of RA-RUs especially for associated EHT STAs, associated HE STAs may have a similar probability of winning RA-RU contention to associated EHT STAs; and associated HE STAs winning RA-RU contention may have a similar probability of successful TB PPDU transmission to associated EHT STAs winning RA-RU contention. Similarly, if the number of RA-RUs for unassociated HE STAs is similar to the number of RA-RUs especially for unassociated EHT STAs, unassociated HE STAs may have a similar probability of winning RA-RU contention to unassociated EHT STAs; and unassociated HE STAs winning RA-RU contention may have a similar probability of successful TB PPDU transmission to unassociated EHT STAs winning RA-RU contention.

The transmit procedure using RA-RUs according to the second method is illustrated in FIG. 16. In this example, a Trigger frame allocates two RA-RUs for associated HE STAs (i.e. RU1 and RU2) and two RA-RUs for unassociated HE STAs (i.e. RU3 and RU4). The Trigger frame also allocates two RA-RUs especially for associated EHT STAs (i.e. RU6 and RU7) and two RA-RUs especially for unassociated EHT STA (i.e. RU8 and RU9). Before the Trigger frame was sent by the AP, HE STA 1, STA 2, STA 3 and STA 4 had initial OBO values of 2, 4, 3 and 5 respectively. EHT STA 1, STA 2, STA 3 and STA 4 had initial OBO values of 6, 2, 3 and 4 respectively. Upon receiving the Trigger frame, HE STA 4, which is associated with the AP and has pending frames for the AP, is allocated a dedicated RU (RU5). The STA does not contend for RA-RUs and instead transmits its pending frames on RU5 using a HE TB PPDU. HE STA 1 and STA 2, both associated with the AP and having pending frames for the AP, decrement their respective OBO counters by the number of eligible RA-RUs for associated HE STAs indicated in the Trigger frame. Since HE STA 1's OBO counter decrements to 0, it transmits its pending frames on RU2 using a HE TB PPDU that it randomly selects from the set of eligible RUs for associated HE STAs (i.e., RU1 and RU2). Since HE STA 2's OBO counter decrements to a nonzero value, it maintains the new OBO value (2) until it receives a later Trigger frame carrying RA-RUs for associated HE STAs. HE STA 3, which is not associated with the AP but has a pending frame for the AP, decrements its OBO counter by the number of eligible RA-RUs for unassociated HE STAs indicated in the Trigger frame. Since HE STA 3's OBO counter decrements to a nonzero value, it maintains the new OBO value (1) until it receives a later Trigger frame carrying RA-RUs for unassociated HE STAs.

On the other hand, EHT STA 1, which is associated with the AP and has pending frames for the AP, is allocated a dedicated RU (RU10). The STA does not contend for RA-RUs and instead transmits its pending frames on RU10 using an EHT TB PPDU. EHT STA 2 and STA 4, both associated with the AP and having pending frames for the AP, decrement their respective OBO counters by the number of eligible RA-RUs for associated EHT STAs indicated in the Trigger frame. Since EHT STA 2's OBO counter decrements to zero, it transmits its pending frames on RU7 using an EHT TB PPDU that it randomly selects from the set of eligible RUs for associated EHT STAs (i.e., RU6 and RU7). Since EHT STA 4's OBO counter decrements to a nonzero value, it maintains the new OBO value (2) until it receives a later Trigger frame carrying RA-RUs for associated EHT STAs. EHT STA 3, which is not associated with the AP but has a pending frame for the AP, decrements its OBO counter by the number of eligible RA-RUs for unassociated EHT STAs indicated in the Trigger frame. Since EHT STA 3's OBO counter decrements to a nonzero value, it maintains the new OBO value (2) until it receives a later Trigger frame carrying RA-RUs for unassociated EHT STAs.

Third Method of UORA:

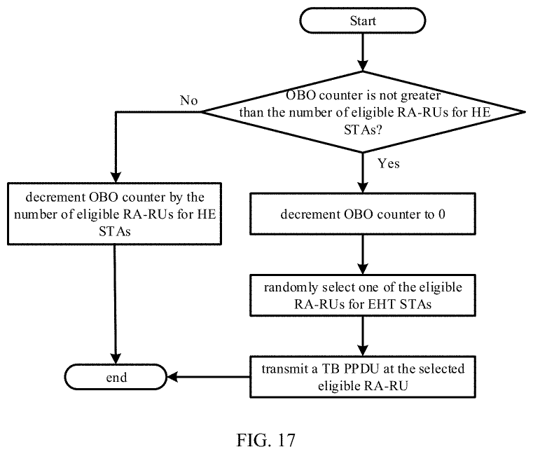

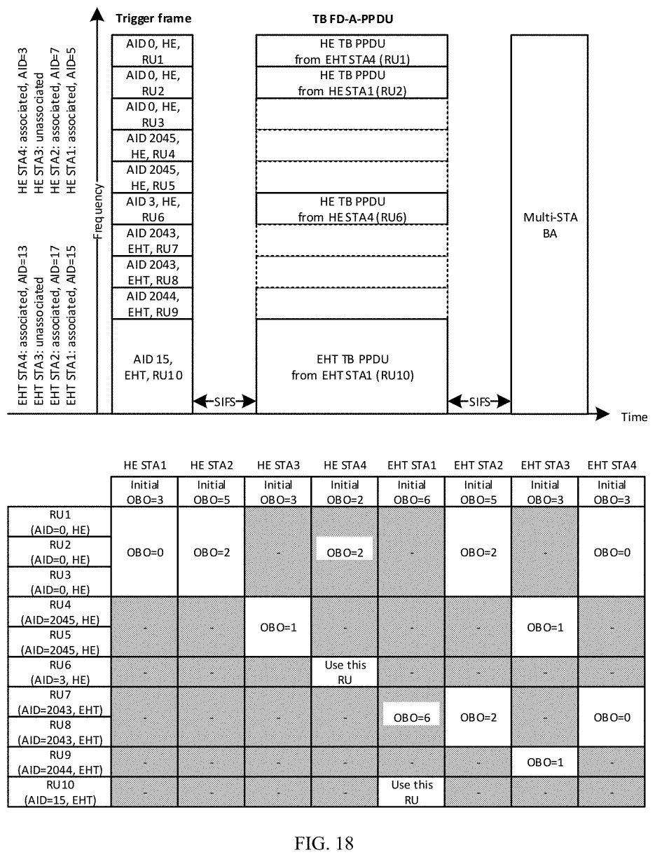

FIG. 17 is a flowchart illustrating a UORA procedure performed by an EHT STA according to a third method provided by an embodiment of the present disclosure. FIG. 18 is a schematic diagram illustrating an example of the UORA procedure according to the third method provided by an embodiment of the present disclosure. A UORA procedure performed by an EHT STA when receiving a Trigger frame from an AP according to the third method is illustrated in FIG. 17. According to the third method, in some embodiments, the STA decrements its OBO counter according to a first RA-RU set indicated in the received Trigger frame, which comprise eligible RA-RUs for HE STAs. If the STA is an associated EHT STA, it shall consider a RA-RU for associated HE STAs to be eligible if it is capable of transmitting a HE TB PPDU in the RA-RU according to the parameters indicated in the Common Info field and in the User Info field that allocates the RA-RU. If the STA is an unassociated EHT STA, it may consider a RA-RU for unassociated HE STAs to be eligible if it supports all the transmit parameters indicated in the Common Info field and in the User Info field that allocates the RA-RU.

The STA determines whether its OBO counter is greater than the number of eligible RA-RUs for HE STAs. If the STA determines its OBO counter is greater than the number of eligible RA-RUs for HE STAs, the STA will decrement its OBO counter by the number of eligible RA-RUs for HE STAs and then stops the UORA procedure. If the STA determines its OBO counter is not greater than the number of eligible RA-RUs for HE STAs, the STA will decrement its OBO counter to zero and win RA-RU contention. After that, the STA randomly selects one of RA-RUs in a second RA-RU set indicated in the received Trigger frame, which comprise eligible RA-RUs for EHT STAs, and then transmit a TB PPDU at the selected RA-RU. The format of the transmitted TB PPDU depends on whether the selected RA-RU is a RA-RU for HE STAs or a RA-RU especially for EHT STAs. If the selected RA-RU is a RA-RU for HE STAs, the transmitted TB PPDU is an HE TB PPDU. If the selected RA-RU is a RA-RU especially for EHT STAs, the transmitted TB PPDU is an EHT TB PPDU.

The transmit procedure using RA-RUs according to the third method is illustrated in FIG. 18. In this example, a Trigger frame allocates three RA-RUs for associated HE STAs (i.e. RU1, RU2 and RU3) and two RA-RUs for unassociated HE STAs (i.e. RU4 and RU5). The Trigger frame also allocates two RA-RUs especially for associated EHT STAs (i.e. RU7 and RU8) and one RA-RU especially for unassociated EHT STA (i.e. RU9). Before the Trigger frame was sent by the AP, HE STA 1, STA 2, STA 3 and STA 4 had initial OBO values of 3, 5, 3 and 2 respectively. EHT STA 1, STA 2, STA 3 and STA 4 had initial OBO values of 6, 5, 3 and 3 respectively. Upon receiving the Trigger frame, HE STA 4, which is associated with the AP and has pending frames for the AP, is allocated a dedicated RU (RU6). The STA does not contend for RA-RUs and instead transmits its pending frames on RU6 using a HE TB PPDU. HE STA 1 and STA 2, both associated with the AP and having pending frames for the AP, decrement their respective OBO counters by the number of eligible RA-RUs for associated HE STAs indicated in the Trigger frame. Since HE STA 1's OBO counter decrements to 0, it transmits its pending frames on RU2 using a HE TB PPDU that it randomly selects from the set of eligible RUs for associated HE STAs (i.e., RU1, RU2 and RU3). Since HE STA 2's OBO counter decrements to a nonzero value, it maintains the new OBO value (2) until it receives a later Trigger frame carrying RA-RUs for associated HE STAs. HE STA 3, which is not associated with the AP but has a pending frame for the AP, decrements its OBO counter by the number of eligible RA-RUs for unassociated HE STAs indicated in the Trigger frame. Since HE STA 3's OBO counter decrements to a nonzero value, it maintains the new OBO value (1) until it receives a later Trigger frame carrying RA-RUs for unassociated HE STAs.

On the other hand, EHT STA 1, which is associated with the AP and has pending frames for the AP, is allocated a dedicated RU (RU10). The STA does not contend for RA-RUs and instead transmits its pending frames on RU10 using an EHT TB PPDU. EHT STA 2 and STA 4, both associated with the AP and having pending frames for the AP, decrement their respective OBO counters by the number of eligible RA-RUs for associated HE STAs indicated in the Trigger frame. Since EHT STA 2's OBO counter decrements to a nonzero value, it maintains the new OBO value (2) until it receives a later Trigger frame carrying RA-RUs for associated EHT STAs. Since EHT STA 4's OBO counter decrements to 0, it transmits its pending frames on RU1 using a HE TB PPDU that it randomly selects from the set of eligible RUs for EHT STAs (i.e., RU1, RU2, RU3, RU7 and RU8). EHT STA 3, which is not associated with the AP but has a pending frame for the AP, decrements its OBO counter by the number of eligible RA-RUs for unassociated HE STAs indicated in the Trigger frame. Since EHT STA 3's OBO counter decrements to a nonzero value, it maintains the new OBO value (1) until it receives a later Trigger frame carrying RA-RUs for unassociated EHT STAs.

According to the third method, in some embodiments, when receiving a Trigger frame, associated HE STAs decrements their respective OBO counters at a same pace as associated EHT STAs regardless of whether the number of RA-RUs for HE STAs is equal to the number of RA-RUs especially for EHT STAs. As a result, associated HE STAs may have a similar probability of winning RA-RU contention to associated EHT STAs. Similarly, unassociated HE STAs may have a similar probability of winning RA-RU contention to unassociated EHT STAs.

According to the third method, in some embodiments, in addition to eligible RA-RU especially for associated EHT STAs, associated EHT STAs winning RA-RU contention can make use of eligible RA-RUs for associated HE STAs for TB PPDU transmission, which may reduce probability of TB PPDU transmission collision among associated EHT STAs winning RA-RU contention. Similarly, probability of TB PPDU transmission collision among unassociated EHT STAs winning RA-RU contention may also be reduced. This may be particularly useful when EHT STAs are much more than HE STAs in an EHT BSS.

Fourth Method of UORA:

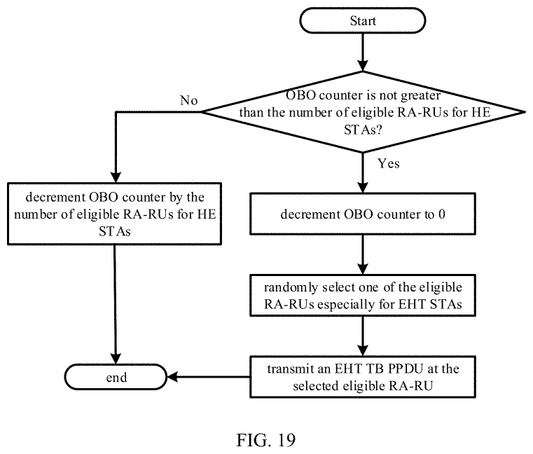

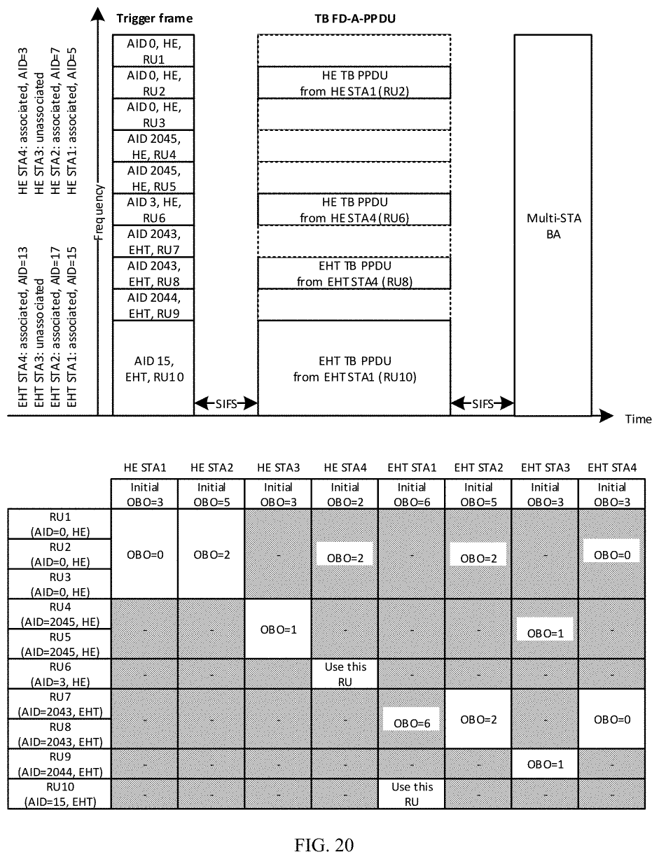

FIG. 19 is a flowchart illustrating a UORA procedure performed by an EHT STA according to a fourth method provided by an embodiment of the present disclosure. FIG. 20 is a schematic diagram illustrating an example of the UORA procedure according to the fourth method provided by an embodiment of the present disclosure. A UORA procedure performed by an EHT STA when receiving a Trigger frame from an AP according to the fourth method is illustrated in FIG. 19. According to the fourth method, in some embodiments, the STA decrements its OBO counter according to a first RA-RU set indicated in the received Trigger frame, which comprise eligible RA-RUs for HE STAs. The STA determines whether its OBO counter is greater than the number of eligible RA-RUs for HE STAs. If the STA determines its OBO counter is greater than the number of eligible RA-RUs for HE STAs, the STA will decrement its OBO counter by the number of eligible RA-RUs for HE STAs and then stops the UORA procedure. If the STA determines its OBO counter is not greater than the number of eligible RA-RUs for HE STAs, the STA will decrement its OBO counter to zero and win RA-RU contention. After that, the STA randomly selects one of RA-RUs in a second RA-RU set indicated in the received Trigger frame, which comprise eligible RA-RUs especially for EHT STAs, and then transmit an EHT TB PPDU at the selected RA-RU.

The transmit procedure using RA-RUs according to the fourth method is illustrated in FIG. 20. In this example, a Trigger frame allocates three RA-RUs for associated HE STAs (i.e. RU1, RU2 and RU3) and two RA-RUs for unassociated HE STAs (i.e. RU4 and RU5). The Trigger frame also allocates two RA-RUs especially for associated EHT STAs (i.e. RU7 and RU8) and one RA-RU especially for unassociated EHT STA (i.e. RU9). Before the Trigger frame was sent by the AP, HE STA 1, STA 2, STA 3 and STA 4 had initial OBO values of 3, 5, 3 and 2 respectively. EHT STA 1, STA 2, STA 3 and STA 4 had initial OBO values of 6, 5, 3 and 3 respectively. Upon receiving the Trigger frame, HE STA 4, which is associated with the AP and has pending frames for the AP, is allocated a dedicated RU (RU6). The STA does not contend for RA-RUs and instead transmits its pending frames on RU6 using a HE TB PPDU. HE STA 1 and STA 2, both associated with the AP and having pending frames for the AP, decrement their respective OBO counters by the number of eligible RA-RUs for associated HE STAs indicated in the Trigger frame. Since HE STA 1's OBO counter decrements to 0, it transmits its pending frames on RU2 using a HE TB PPDU that it randomly selects from the set of eligible RUs for associated HE STAs (i.e., RU1, RU2 and RU3). Since HE STA 2's OBO counter decrements to a nonzero value, it maintains the new OBO value (2) until it receives a later Trigger frame carrying RA-RUs for associated HE STAs. HE STA 3, which is not associated with the AP but has a pending frame for the AP, decrements its OBO counter by the number of eligible RA-RUs for unassociated HE STAs indicated in the Trigger frame. Since HE STA 3's OBO counter decrements to a nonzero value, it maintains the new OBO value (1) until it receives a later Trigger frame carrying RA-RUs for unassociated HE STAs.

On the other hand, EHT STA 1, which is associated with the AP and has pending frames for the AP, is allocated a dedicated RU (RU10). The STA does not contend for RA-RUs and instead transmits its pending frames on RU10 using an EHT TB PPDU. EHT STA 2 and STA 4, both associated with the AP and having pending frames for the AP, decrement their respective OBO counters by the number of eligible RA-RUs for associated HE STAs indicated in the Trigger frame. Since EHT STA 2's OBO counter decrements to a nonzero value, it maintains the new OBO value (2) until it receives a later Trigger frame carrying RA-RUs for associated EHT STAs. Since EHT STA 4's OBO counter decrements to 0, it transmits its pending frames on RU8 using an EHT TB PPDU that it randomly selects from the set of eligible RUs especially for EHT STAs (i.e., RU7 and RU8). EHT STA 3, which is not associated with the AP but has a pending frame for the AP, decrements its OBO counter by the number of eligible RA-RUs for unassociated HE STAs indicated in the Trigger frame. Since EHT STA 3's OBO counter decrements to a nonzero value, it maintains the new OBO value (1) until it receives a later Trigger frame carrying RA-RUs for unassociated EHT STAs.

According to the fourth method, in some embodiments, when receiving a Trigger frame, associated HE STAs decrements their respective OBO counters at a same pace as associated EHT STAs regardless of whether the number of RA-RUs for HE STAs is equal to the number of RA-RUs especially for EHT STAs. As a result, associated HE STAs may have a similar probability of winning RA-RU contention to associated EHT STAs. Similarly, unassociated HE STAs may have a similar probability of winning RA-RU contention to unassociated EHT STAs.

According to the fourth method, in some embodiments, associated EHT STAs winning RA-RU contention can only make use of eligible RA-RUs especially for associated HE STAs for TB PPDU transmission, which may reduce probability of TB PPDU transmission collision among associated EHT STAs winning RA-RU contention and associated HE STAs winning RA-RU contention. Similarly, probability of TB PPDU transmission collision among unassociated EHT STAs winning RA-RU contention and unassociated HE STAs winning RA-RU contention may also be reduced. This may be particularly useful when the number of EHT STAs are equal to or less than the number of HE STAs in an EHT BSS.

According to the present invention, in some embodiments, in addition to the abovementioned four methods of UORA, the other methods for UORA may be possible. For one example, the first RA-RU set comprises eligible RA-RUs especially for EHT STAs and the second RA-RU set comprises eligible RA-RUs for EHT STAs. For another example, the first RA-RU set comprises eligible RA-RUs for EHT STAs and the second RA-RU set comprises eligible RA-RUs especially for EHT STAs.

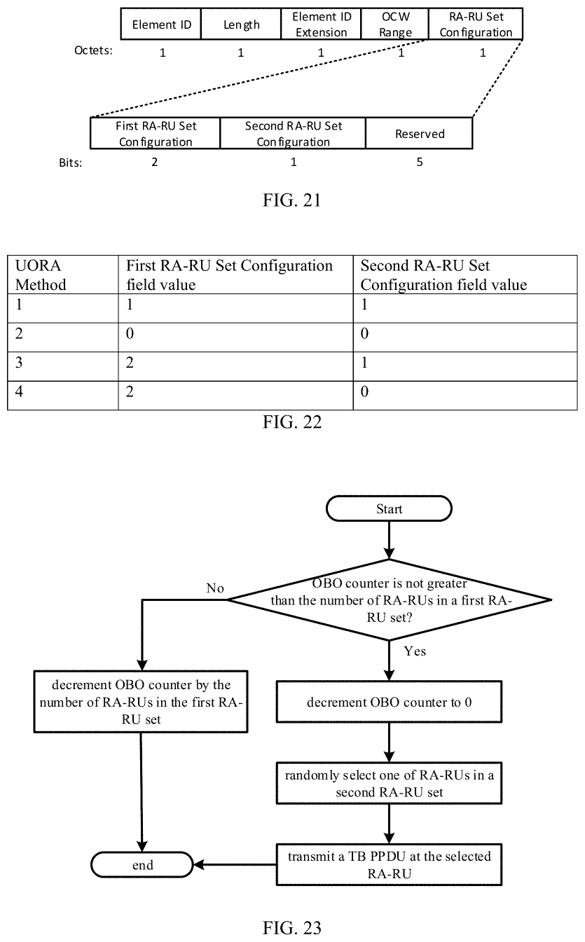

FIG. 21 illustrates an example of a first information element format according to an embodiment of the present disclosure. According to the present invention, in some embodiments, the first RA-RU set and the second RA-RU set used by EHT STAs for UORA may be configured by an AP according to practical BSS deployment. The first information element included in a management frame such as Beacon frame, Probe Response frame or Association Response frame signals the metrics of the UORA mechanism including configuration information on the first RA-RU set and the second RA-RU set. The format of the first information element is illustrated in FIG. 21. The first information element may refer to a UORA Parameter Set element. The first information element may comprise a first field which indicates configuration information on the first RA-RU set and a second field which indicates configuration information on the second RA-RU set used by EHT STAs for UORA. The first field may refer to a First RA-RU Set Configuration field and the second field may refer to a Second RA-RU Set Configuration field. In some embodiments, the first field can be set to different values to indicate that the first RA-RU set comprises eligible RA-RUs especially for EHT STAs, the first RA-RU set comprises eligible RA-RUs for EHT STAs, and the first RA-RU set comprises eligible RA-RUs for HE STAs, respectively. In an example, the first field is set to 0 to indicate the first RA-RU set comprises eligible RA-RUs especially for EHT STAs; set to 1 to indicate the first RA-RU set comprises eligible RA-RUs for EHT STAs; and set to 2 to indicate the first RA-RU set comprises eligible RA-RUs for HE STAs. In some embodiments, the second field can be set to different value to indicate that the second RA-RU set comprises eligible RA-RUs especially for EHT STAs and the second RA-RU set comprises eligible RA-RUs for EHT STAs, respectively. In an example, the second field is set to 0 to indicate the second RA-RU set comprises eligible RA-RUs especially for EHT STAs; and set to 1 to indicate the second RA-RU set comprises eligible RA-RUs for EHT STAs.

FIG. 22 illustrates an example of correspondence between four UORA methods and field settings of the first information element according to an embodiment of the present disclosure. FIG. 22 illustrates that, in some embodiments, in the first UORA method, the first RA-RU set configuration subfield value is set to 1, and the second RA-RU set configuration subfield value is set to 1. In some embodiments, in the second UORA method, the first RA-RU set configuration subfield value is set to 0, and the second RA-RU set configuration subfield value is set to 0. In some embodiments, in the third UORA method, the first RA-RU set configuration subfield value is set to 2, and the second RA-RU set configuration subfield value is set to 1. In some embodiments, in the fourth UORA method, the first RA-RU set configuration subfield value is set to 2, and the second RA-RU set configuration subfield value is set to 0.

FIG. 23 is a flowchart illustrating a UORA procedure performed by an EHT STA according to an embodiment of the present disclosure. According to some embodiments of the present invention, a general UORA procedure performed by an EHT STA is described in FIG. 23. When receiving a Trigger frame from an AP, the STA is able to determine a first RA-RU set and a second RA-RU set according to RA-RU set configuration information included in a previously received first information element from the AP. The STA determines whether its OBO counter is greater than the number of RA-RUs in the first RA-RU set. If the STA determines its OBO counter is greater than the number of RA-RUs in the first RA-RU set, the STA will decrement its OBO counter by the number of RA-RUs in the first RA-RU set and then stops the UORA procedure. If the STA determines its OBO counter is not greater than the number of RA-RUs in the first RA-RU set, the STA will decrement its OBO counter to zero and win RA-RU contention. After that, the STA randomly selects one of RA-RUs in the second RA-RU set, and then transmit a TB PPDU at the selected RA-RU. The format of the transmitted TB PPDU depends on whether the selected RA-RU is a RA-RU for HE STAs or a RA-RU especially for EHT STAs. If the selected RA-RU is a RA-RU for HE STAs, the transmitted TB PPDU is an HE TB PPDU. If the selected RA-RU is a RA-RU especially for EHT STAs, the transmitted TB PPDU is an EHT TB PPDU.

In some embodiments, Post-EHT WLAN will be the next-generation WLAN immediately after EHT WLAN. According to the present invention, HE STAs, EHT STAs and post-EHT STAs may coexist in a post-EHT BSS in future. To improve system throughput in a post-EHT BSS, a 320 MHz BW TB FD-A-PPDU may comprise one or more HE TB PPDUs, one or more EHT TB PPDUs and one or more post-EHT TB PPDUs. UORA in a TB FD-A-PPDU comprising one or more HE TB PPDUs, one or more EHT TB PPDUs and one or more post-EHT TB PPDUs can be implemented in a similar manner to a TB FD-A-PPDU comprising one or more HE TB PPDUs and one or more EHT TB PPDUs.

In summary, the above embodiments propose an access point (AP), a station (STA), and a wireless communication method, which can solve issues in the prior art, perform an uplink random access by STAs using a TB A-PPDU in an efficient manner, improve peak-to-average power ratio (PAPR) of the A-PPDU, achieve extremely high throughput (EHT), provide a good communication performance, and/or provide high reliability. The wireless communication method is related to a method for performing an uplink OFDMA based random access. The above embodiments address how to perform an uplink orthogonal frequency division multiple access (OFDMA) based random access (UORA) by extremely high throughput (EHT) stations (STAs) using a trigger based (TB) frequency-domain (FD) aggregated physical layer (PHY) protocol data unit (A-PPDU) (FD-A-PPDU) in an efficient manner. According to some embodiments of the present invention, in a trigger frame, when an association identifier 12 (AID12) subfield of a user info field is set to a first value, the user info field allocates one or more contiguous random access resource units (RA-RUs) with a same size especially for associated EHT STAs; and when the AID12 subfield is set to a second value, the user info field allocates one or more contiguous RA-RUs with a same size especially for unassociated EHT STAs.

According to some embodiments of the present invention, when a Trigger frame is used to solicit a TB FD-A-PPDU transmission from high efficiency (HE) STAs and EHT STAs, if the Trigger frame comprises at least one User Info field with the AID12 subfield set to the first value, the Trigger frame also comprises at least one User Info field with the AID12 subfield set to 0. Similarly, if the Trigger frame comprises at least one User Info field with the AID12 subfield set to the second value, the Trigger frame also comprises at least one User Info field with the AID12 subfield set to 2045. According to some embodiments of the present invention, when a Trigger frame comprises at least one User Info field with the AID12 subfield set to the first or second value and at least one User Info field with the AID12 subfield set to 0 or 2045, the at least one User Info field with the AID12 subfield set to the first or second value and the at least one User Info field with the AID12 subfield set to 0 or 2045 are placed at the end of the User Info List field of the Trigger frame.

According to some embodiments of the present invention, in a UORA procedure performed by an EHT STA, when receiving a Trigger frame from an AP, the EHT STA decrements its OFDMA random access backoff (OBO) counter according to a first RA-RU set indicated in the received Trigger frame. In a first embodiment, the first RA-RU set comprises eligible RA-RUs for HE STAs indicated in the received Trigger frame. In a second embodiment, the first RA-RU set comprises eligible RA-RUs for EHT STAs indicated in the received Trigger frame. In a third embodiment, the first RA-RU set comprises eligible RA-RUs for EHT STAs indicated in the received Trigger frame. The STA determines whether its OBO counter is greater than the number of RA-RUs in a first RA-RU set. If the STA determines its OBO counter is greater than the number of RA-RUs in the first RA-RU set, the STA will decrement its OBO counter by the number of RA-RUs in the first RA-RU set and then stops the UORA procedure. If the STA determines its OBO counter is not greater than the number of RA-RUs in the first RA-RU set, the STA will decrement its OBO counter to zero and win RA-RU contention. After that, the STA randomly selects one of RA-RUs in a second RA-RU set indicated in the received Trigger frame, and then transmit a TB PPDU at the selected RA-RU. In a first embodiment, the second RA-RU set comprises eligible RA-RUs especially for EHT STAs indicated in the received Trigger frame. In a second embodiment, the second RA-RU set comprises eligible RA-RUs for EHT STAs indicated in the received Trigger frame. The format of the transmitted TB PPDU depends on whether the selected RA-RU is a RA-RU for HE STAs or a RA-RU especially for EHT STAs. If the selected RA-RU is a RA-RU for HE STAs, the transmitted TB PPDU is a HE TB PPDU. If the selected RA-RU is a RA-RU especially for EHT STAs, the transmitted TB PPDU is an EHT TB PPDU. According to some embodiments of the present invention, an AP may transmit a first information element which indicates configuration information on the first RA-RU set and the second RA-RU set.

Commercial interests for some embodiments are as follows. 1. Solving issues in the prior art. 2. Performing an uplink random access by STAs using a TB A-PPDU in an efficient manner. 3. Improving peak-to-average power ratio (PAPR) of the A-PPDU. 4. Achieving extremely high throughput (EHT). 5. Improving system throughput in an EHT BSS. 6. Providing a good communication performance. 7. Providing a high reliability. 8. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or to standards create an end product. Some embodiments of the present disclosure propose technical mechanisms.

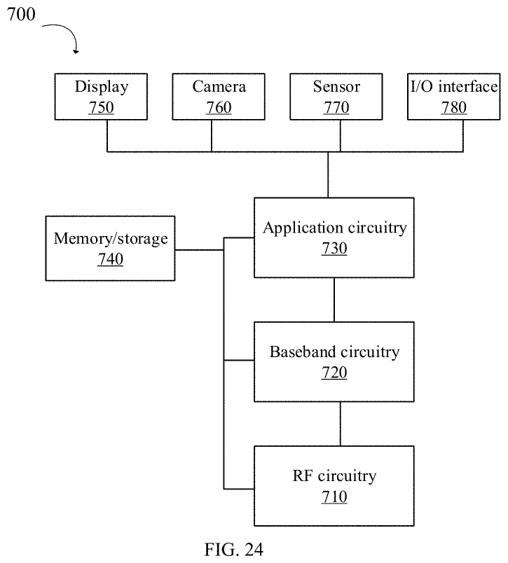

FIG. 24 is a block diagram of an example system 700 for wireless communication according to an embodiment of the present disclosure. Embodiments described herein may be implemented into the system using any suitably configured hardware and/or software. FIG. 24 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP or STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method, comprising:
configuring, by an access point (AP), a trigger based (TB) aggregated physical layer (PHY) protocol data unit (A-PPDU) to a set of stations (STAs), wherein:
in a trigger frame,
when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or
when the AID subfield is set to a second value different from the first value and a value range of the second value is [2008, 2044] or [2047, 4094], the user information field allocates one or more contiguous RA-RUs with a same size for unassociated STAs in the set of STAs.

2. The wireless communication method of claim 1, wherein the AID subfield comprises an AID12 subfield.

3. The wireless communication method of claim 1, wherein the set of STAs comprises high efficiency (HE) STAs and/or extremely high throughput (EHT) STAs, and the trigger frame is used to solicit a TB A-PPDU transmission from the HE STAs and/or the EHT STAs.

4. The wireless communication method of claim 3, wherein:
if the AID subfield is set to the first value, the associated STAs comprises associated EHT STAs, and/or the trigger frame further comprises a user information field with an AID subfield set to 0; and/or
if the AID subfield is set to the second value, the unassociated STAs comprises unassociated EHT STAs, and/or the trigger frame further comprises a user information field with an AID subfield set to 2045.

5. The wireless communication method of claim 3, wherein the first value of the AID subfield comprises 2043, and/or the second value of the AID subfield comprises 2044.

6. The wireless communication method of claim 1, wherein the trigger frame comprises a user information list field, and the user information field with the AID subfield set to the first value or the second value is placed at an end of the user information list field of the trigger frame.

7. The wireless communication method of claim 1, wherein the user information field with the AID subfield set to the first value or the second value and the user information field with the AID subfield set to 0 or 2045 are placed at an end of a user information list field of the trigger frame.

8. The wireless communication method of claim 1, wherein in an uplink orthogonal frequency division multiple access (OFDMA) based random access (UORA) procedure performed by the STA, when the trigger frame is received by the STA from the AP, the STA decrements a OFDMA random access backoff (OBO) counter according to a first RA-RU set indicated in the received trigger frame.

9. The wireless communication method of claim 8, wherein the first RA-RU set comprises eligible RA-RUs for the STAs indicated in the received trigger frame.

10. The wireless communication method of claim 8, wherein the first RA-RU set comprises eligible RA-RUs for extremely high throughput (EHT) STAs or for high efficiency (HE) STAs indicated in the received trigger frame.

11. The wireless communication method of claim 9, wherein the STA is configured to determine whether the OBO counter is greater than a number of RA-RUs in the first RA-RU set.

12. The wireless communication method of claim 11, wherein if the STA determines the OBO counter is greater than the number of RA-RUs in the first RA-RU set, the STA decrements the OBO counter by the number of RA-RUs in the first RA-RU set and stops the UORA procedure.

13. The wireless communication method of claim 11, wherein if the STA determines the OBO counter is not greater than the number of RA-RUs in the first RA-RU set, the STA decrements the OBO counter to zero.

14. The wireless communication method of claim 13, wherein when the STA determines the OBO counter is not greater than the number of RA-RUs in the first RA-RU set, the STA randomly selects one of RA-RUs in a second RA-RU set indicated in the received trigger frame and transmits a TB PPDU at the selected RA-RU.

15. The wireless communication method of claim 14, wherein the second RA-RU set comprises eligible RA-RUs for the STAs indicated in the received trigger frame.

16. The wireless communication method of claim 14, wherein the second RA-RU set comprises eligible RA-RUs for the EHT STAs, especially for the EHT STAs, or for the HE STAs indicated in the received trigger frame.

17. The wireless communication method of claim 14, wherein a format of the transmitted TB PPDU depends on whether the selected RA-RU is a RA-RU for the HE STAs or a RA-RU especially for the EHT STAs.

18. The wireless communication method of claim 17, wherein if the selected RA-RU is the RA-RU for the HE STAs, the transmitted TB PPDU is a HE TB PPDU.

19. An access point (AP), comprising:
a memory;
a transceiver; and
a processor coupled to the memory and the transceiver;
wherein the processor is configured to configure a trigger based (TB) aggregated physical layer (PHY) protocol data unit (A-PPDU) to a set of stations (STAs), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs.

20. A station (STA), comprising:
a memory;
a transceiver; and
a processor coupled to the memory and the transceiver;
wherein the processor is configured to determine a trigger based (TB) aggregated physical layer (PHY) protocol data unit (A-PPDU) from an access point (AP), wherein in a trigger frame, when an association identifier (AID) subfield of a user information field is set to a first value and a value range of the first value is [2008, 2044] or [2047, 4094], the user information field allocates one or more contiguous random access resource units (RA-RUs) with a same size for associated STAs in the set of STAs, and/or when the AID subfield is set to a second value different from the first value and a value range of the second value is [2008, 2044] or [2047, 4094], the user information field allocates one or more contiguous RA-RUs with a same size for unassociated STAs in the set of STAs.
